(19) United States
(12) Patent Application Publication
(10) Pub. No.: US 2005/0212914 A1
(43) Pub. Date: Sep. 29, 2005

(54) Method, apparatus, system, and computer executable program for image processing

(75) Inventors: Hideo Seto, Kanagawa (JP); Hisashi Ohara, Kanagawa (JP); Masahiro Kubo, Kanagawa (JP); Satoshi Ozawa, Kanagawa (JP); Masayuki Ryuto, Kanagawa (JP); Takayuki Iida, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/087,765

(22) Filed: Mar. 24, 2005

(30) Foreign Application Priority Data
Mar. 25, 2004 (JP) 2004-090111
Mar. 25, 2004 (JP) 2004-090112
Mar. 26, 2004 (JP) 2004-093627

(51) Int. Cl. H04N 5/225

(52) U.S. Cl. 348/207.1

(57) ABSTRACT

A digital still camera produces size-reduced image data of a JPEG file, which is converted into printable image data of a TIFF file according to a converting parameter. In the digital still camera, raw image data (CCD-RAW) is produced, corresponds to the JPEG data, and has an unreduced format. Images of the JPEG data are displayed in a playback manner. A customer order of an image among the displayed images to be printed is processed. JPEG data associated with the image of the customer order is adjusted according to a standard adjusting parameter. The standard adjusting parameter is modified into a first adjusting parameter. Raw image data associated with the image of the customer order is converted into TIFF data by image conversion according to the first adjusting parameter and/or a standard converting parameter being preset.

### BACKGROUND OF THE INVENTION

1. Field of the Invention

The present invention relates to a method, apparatus, system, and computer executable program for image processing. More particularly, the present invention relates to a method, apparatus, system, and computer executable program for image processing, in which images can be selected suitably in order to convert the electronic format of an image data file in an efficient manner.

2. Description Related to the Prior Art

There is a digital still camera for professional use, which outputs raw image data or unprocessed image data upon photographing an object. The raw image data is called CCD-RAW data in an unchanged form output by CCD, CMOS or other image pickup elements incorporated in the digital still camera. A data size of the raw image data is a number of times as large as that of image data of the JPEG (Joint Photographic Coding Expert Group) format as outputs of the digital still camera in a popular type for non-professional users. However, the raw image data is used with advantages in that white balance, exposure, and other items of an image can be corrected without missing information of colors after the image pickup, and widely used in imaging with high quality and for professional use.

The raw image data cannot be used for displaying an image on a display panel of the computer, or printing in an image forming apparatus. It is general that the raw image data is input to a computer, and processed according to an image converting program installed in the computer, and converted by image conversion processing into printable image data with which an image can be displayed and printed. An example of the format of the printable image data is the TIFF (Tagged Image File Format). Also, the data is subjected to image correction according to a converting parameter and an adjusting parameter, the converting parameter being related to white balance correction, exposure correction and the like, the adjusting parameter being related to adjusting color tone, gradation, contrast and the like.

Also, there is a known type of the digital still camera which outputs the raw image data and also size-reduced image data, for example JPEG image data.

Examples of this are U.S. Patent Pub. No. 2003/184,652 (corresponding to JP-A 2003-289498), and information disclosed in the following web page:

Canon EOS-1Ds Camera, Canon Incorporated, http://cweb.canon.jp/camera/eosd/1ds/catalog/index03.html accessed on 9 Mar. 2004.

For example, the digital still camera for outputting the raw image data is used in a photo studio, to photograph a portrait of a customer. This is followed by various steps for photofinishing, including order acceptance, image analysis, the image conversion processing, printing, and dispatch of prints.

The order acceptance is to subject the raw image data or unprocessed image data to the image conversion processing, and to have the customer to browse an image of the printable image data on a display panel of the order processing computer, and to have him or her select images to be printed. Information is input, including selected images to be printed, numbers of prints, and printing sizes. It is possible in the order acceptance to receives various data according to the request, for example, a trimming size, an image orientation, color tone, brightness and the like. After the order acceptance is completed, ordering data is produced according to the various data and ID information of the customer.

For the analysis and the image conversion processing, the image analyzing computer converts the raw image data into the printable image data according to the converting and adjusting parameters, modifies the converting and adjusting parameters while an image of the printable image data is visually observed, and produces an image with higher image quality. The raw image data is subjected to the image conversion processing at each time that the converting and adjusting parameters are modified, to renew the printable image data. An operator observes the newest image of the printable image data, and if he or she desires, modifies the parameters and repeats the image conversion processing until high quality is obtained. In the printing, the printable image data after the analysis is output to print an image according to ordering data. In the dispatch, prints obtained by the printing are forwarded to a customer.

The raw image data is constituted by numerous data of pixels having 12-bit or 16-bit gradation for each of the colors. A size of the data is extremely large to take much time in the image conversion processing of the raw image data. If the image conversion processing of the raw image data of plural images is effected after image pickup, the order acceptance cannot be start immediately. Customers are obliged to wait for the lapse of time for the image conversion processing of the raw image data.

It is likely in the analysis and the image conversion processing that the raw image data must be converted for plural times, which results in much time in operation, and low efficiency. As the environment in the image pickup in the photo studio has small changes unless exceptional situations occur. If images of the raw image data are photographed in one studio, analysis for the raw image data of those is nearly equal to one another. However, the image analysis of the prior art cannot be made at high efficiency, because an operator must analyze the raw image data one after another discretely.

### SUMMARY OF THE INVENTION

In view of the foregoing problems, an object of the present invention is to provide a method, apparatus, system, and computer executable program for image processing, in which images can be selected suitably in order to convert the electronic format of an image data file in an efficient manner.

In order to achieve the above and other objects and advantages of this invention, an image processing method of image processing of raw image data obtained by image pickup in a digital camera is provided. The digital camera produces a size-reduced image from the raw image data by size reduction, and writes data of the size-reduced image and the raw image data to a storage medium electrically. In the image processing method, plural size-reduced images read from the storage medium are displayed on a display panel. A customer order of printing is processed by designating a selected one of the size-reduced images on the display panel. The selected size-reduced image is processed according to a standard adjusting parameter. The standard adjusting parameter is modified to determine a modified adjusting parameter by considering preference in image quality. Selected raw image data is converted into a printable image according to a prescribed converting parameter, the selected raw image data being associated with the selected size-reduced image, and read from the storage medium. The printable image is processed according to the modified adjusting parameter.

The raw image data is constituted by a three-color set of image signals output by an image pickup device of the digital camera, the size-reduced images are constituted by a signal obtained by JPEG compression of a color difference signal, and the printable image is constituted by a printer adapted signal.

Furthermore, ordering data is produced according to the customer order, the ordering data being adapted to image adjustment and image conversion.

Furthermore, quality modifying preference information for the size-reduced image data is processed in processing the customer order. The size-reduced image data of the image of the customer order is adjusted by image adjustment according to the quality modifying preference information and the standard adjusting parameter.

Raw image data included in the raw image data and associated with the image of the customer order is input from the digital camera.

Furthermore, a selected one of first and second modes is set. If the first mode is set, the size-reduced image data is analyzed for image analysis, and for image conversion of the raw image data according to a standard converting parameter being preset and the first adjusting parameter obtained by the image analysis with the size-reduced image data. If the second mode is set, the raw image data is thinned at a regular proportion to produce thinned raw image data. The raw image data of the image of the customer order is converted into printable image data for image conversion according to an auxiliary converting parameter and an auxiliary adjusting parameter obtained by image analysis with the thinned raw image data.

Furthermore, possibility of analyzing the size-reduced image data is checked for image analysis. In case of possibility of the image analysis with the size-reduced image data, the standard adjusting parameter is modified into the first adjusting parameter according to the image analysis. After the image analysis with the size-reduced image data, the raw image data is converted for image conversion according to the standard converting parameter and the first adjusting parameter. Further, the raw image data is thinned at a regular proportion to produce thinned raw image data. In case of failure of the image analysis with the size-reduced image data, the thinned raw image data is analyzed for image analysis. In case of the image analysis with the thinned raw image data, the raw image data is converted into printable image data for image conversion according to an auxiliary converting parameter and an auxiliary adjusting parameter obtained by the image analysis.

According to another aspect of the invention, an image processing apparatus for image conversion processing is provided. An image input unit inputs the size-reduced image data and raw image data being produced by the image pickup in the digital camera, corresponding to the size-reduced image data, and having an unreduced format. A size-reduced image display device displays images of the size-reduced image data in a playback manner. An order processor processes a customer order of an image among the displayed images to be printed. An ordering data generator produces ordering data according to the customer order. A size-reduced image data adjuster adjusts size-reduced image data of the image of the customer order by the ordering data for image adjustment according to the standard adjusting parameter. A parameter modifier modifies the standard adjusting parameter into a first adjusting parameter. A printable image data generator converts raw image data of the image of the customer order associated with the ordering data into printable image data, by image conversion according to the first adjusting parameter and/or a standard converting parameter being preset.

The order processor further processes quality modifying preference information in processing the customer order. The ordering data generator generates modifying data according to the quality modifying preference information. The size-reduced image data adjuster adjusts the size-reduced image data by image adjustment according to the modifying data and the first adjusting parameter.

Furthermore, a mode selector sets a selected one of first and second modes. A thinned raw image data generator, if the second mode is set, thins the raw image data at a regular proportion, to produce thinned raw image data. The parameter modifier, if the first mode is set, analyzes the size-reduced image data for image analysis, and if the second mode is set, analyzes the thinned raw image data for image analysis. The printable image data generator, if the first mode is set, converts the raw image data for image conversion according to the standard converting parameter and the first adjusting parameter, and if the second mode is set, converts the raw image data into printable image data for image conversion according to an auxiliary converting parameter and an auxiliary adjusting parameter obtained by the parameter modifier.

Furthermore, a thinned raw image data generator thins the raw image data at a regular proportion, to produce thinned raw image data. The parameter modifier, in case of possibility of image analysis with the size-reduced image data, analyzes the size-reduced image data for image analysis, and in case of failure of the image analysis with the size-reduced image data, analyzes the thinned raw image data for image analysis. The printable image data generator, in case of the image analysis with the size-reduced image data, converts the raw image data for image conversion according to the standard converting parameter being preset and the first adjusting parameter, and in case of the image analysis with the thinned raw image data, converts the raw image data into printable image data for image conversion according to an auxiliary converting parameter and an auxiliary adjusting parameter obtained by the parameter modifier.

According to one aspect of the invention, an image processing system is provided, and is constituted by a digital camera and an image processing apparatus in combination therewith.

According to still another aspect of the invention, a computer executable image processing program for image processing including plural program codes is provided. The plural program codes include a program code for inputting size-reduced image data by image pickup of a digital camera. A program code is for displaying images of the size-reduced image data are displayed in a playback manner. A program code is for processing a customer order of an image among the displayed images to be printed. A program code is for producing ordering data according to the customer order.

Furthermore, the size-reduced image data of the image of the customer order associated with the ordering data is adjusted for image adjustment according to the standard adjusting parameter. The standard adjusting parameter is modified into a first adjusting parameter for use newly in image adjustment.

Furthermore, raw image data is input by the image pickup of the digital camera, the raw image data corresponding to the size-reduced image data and having an unreduced format. The raw image data is converted into printable image data by image conversion according to the first adjusting parameter and/or the standard converting parameter being preset.

Furthermore, raw image data is input from the digital camera, the raw image data corresponding to the size-reduced image data and having an unreduced format a selected one of first and second modes is set. If the second mode is set, the raw image data is thinned at a regular proportion, to produce thinned raw image data.

Furthermore, the raw image data is thinned at a regular proportion, to produce thinned raw image data.

Furthermore, an image of the printable image data associated with the customer order is displayed in a playback manner. A standard adjusting parameter is modified into a first adjusting parameter. The printable image data of the displayed image is adjusted by image adjustment according to the standard adjusting parameter, or according to the first adjusting parameter.

According to another aspect of the invention, a user interface for image conversion processing is provided. An image input region inputs the size-reduced image data and raw image data being produced by the image pickup in the digital camera, corresponding to the size-reduced image data, and having an unreduced format. A size-reduced image display region displays images of the size-reduced image data in a playback manner. An order processing region processes a customer order of an image among the displayed images to be printed. An ordering data generating region produces ordering data according to the customer order. A size-reduced image data adjusting region adjusts size-reduced image data of the image of the customer order by the ordering data for image adjustment according to the standard adjusting parameter. A parameter modifying region modifies the standard adjusting parameter into a first adjusting parameter. A printable image data generating region converts raw image data of the image of the customer order associated with the ordering data into printable image data, by image conversion according to the first adjusting parameter and/or a standard converting parameter being preset.

According to one aspect of the invention, an image processing apparatus is for image conversion processing of size-reduced image data into printable image data according to a converting parameter, the size-reduced image data being produced by image pickup in a digital camera. In the image processing apparatus, an image input unit inputs the size-reduced image data and raw image data being produced by the image pickup in the digital camera, corresponding to the size-reduced image data, and having an unreduced format. A mode selector sets a selected one of first and second modes. A thinned raw image data generator is operated if the second mode is set, for thinning the raw image data at a regular proportion, to produce thinned raw image data. There is an image analyzer for image analysis of the size-reduced image data if the first mode is set, and for image analysis of the thinned raw image data if the second mode is set. A printable image data generator is operated if the first mode is set, for image conversion of the raw image data according to a standard converting parameter being preset and a first adjusting parameter obtained by the image analyzer, and operated if the second mode is set, for image conversion of the raw image data into printable image data according to an auxiliary converting parameter and an auxiliary adjusting parameter obtained by the image analyzer.

According to another aspect of the invention, an image processing apparatus includes an image input unit for inputting the size-reduced image data and raw image data being produced by the image pickup in the digital camera, corresponding to the size-reduced image data, and having an unreduced format. A thinned raw image data generator thins the raw image data at a regular proportion, to produce thinned raw image data. An image analyzer analyzes the size-reduced image data for image analysis, and, in case of failure of the image analysis with the size-reduced image data, analyzes the thinned raw image data for image analysis. A printable image data generator, in case of the image analysis with the size-reduced image data, converts the raw image data for image conversion according to a standard converting parameter being preset and a first adjusting parameter obtained by the image analyzer, and in case of the image analysis with the thinned raw image data, converts the raw image data into printable image data for image conversion according to an auxiliary converting parameter and an auxiliary adjusting parameter obtained by the image analyzer.

According to one aspect of the invention, a computer executable image processing program for image processing including plural program codes is provided. A selected one of first and second modes is set. The size-reduced image data and the raw image data are input from the digital camera if the first mode is set, and the raw image data is input from the digital camera if the second mode is set, the raw image data corresponding to the size-reduced image data and having an unreduced format. If the second mode is set, the raw image data is thinned at a regular proportion to produce thinned raw image data.

According to another aspect of the invention, a computer executable image processing program for image processing including plural program codes is provided. Size-reduced image data is input by image pickup in a digital camera. Raw image data is input by the image pickup of the digital camera, the raw image data corresponding to the size-reduced image data and having an unreduced format. The raw image data is thinned at a regular proportion to produce thinned raw image data.

According to one aspect of the invention, a user interface for image processing including plural steps is provided. A mode selecting region sets a selected one of first and second modes. An image input region inputs the size-reduced image data and the raw image data from the digital camera if the first mode is set, and inputs the raw image data from the digital camera if the second mode is set, the raw image data corresponding to the size-reduced image data and having an unreduced format. A thinned raw image data generating region, if the second mode is set, thins the raw image data at a regular proportion to produce thinned raw image data.

According to another aspect of the invention, a user interface for image processing including plural steps is provided. An image input region inputs size-reduced image data by image pickup in a digital camera. The image input region inputs raw image data by the image pickup of the digital camera, the raw image data corresponding to the size-reduced image data and having an unreduced format. A thinned raw image data generating region thins the raw image data at a regular proportion to produce thinned raw image data.

According to one aspect of the invention, an image processing apparatus for image conversion processing is provided. An image input unit inputs the size-reduced image data and raw image data being produced by the image pickup in the digital camera, corresponding to the size-reduced image data, and having an unreduced format. A printable image data generator converts the raw image data into printable image data by image conversion according to the converting parameter being preset. A size-reduced image display device displays images of the size-reduced image data in a playback manner. An order processor processes a customer order of an image among the displayed images to be printed. An ordering data generator produces ordering data according to the customer order. A printable image display device displays an image of the printable image data associated with the customer order in a playback manner. A parameter modifier modifies a standard adjusting parameter into a first adjusting parameter. An image adjuster adjusts the printable image data of the displayed image by image adjustment according to the standard adjusting parameter, or according to the first adjusting parameter.

The order processor further processes quality modifying preference information in processing the customer order, and the ordering data generator generates modifying data according to the quality modifying preference information.

In one preferred embodiment, the printable image data generator converts the raw image data into the printable image data according to the modifying data and the converting parameter.

In another preferred embodiment, furthermore, a raw image data adjuster adjusts the raw image data by image adjustment according to the modifying data.

In still another preferred embodiment, the image adjuster adjusts the printable image data according to the modifying data and the standard adjusting parameter.

### BRIEF DESCRIPTION OF THE DRAWINGS

The above objects and advantages of the present invention will become more apparent from the following detailed description when read in connection with the accompanying drawings, in which:

FIG. 1 is a block diagram schematically illustrating a system for image conversion processing;

FIG. 2 is a block diagram schematically illustrating a combination of a digital still camera and a camera control computer;

FIG. 3 is a pattern diagram illustrating a structure of data files of image data in a storage;

FIG. 4 is a pattern diagram illustrating a structure of data files of image data in an external storage device;

FIG. 5 is a front view illustrating appearance of an order processing pattern as user interface;

FIG. 6 is a front view illustrating appearance of an image adjusting pattern;

FIG. 7 is a pattern diagram illustrating a structure of data files in an ordering data folder;

FIG. 8 is a front view illustrating appearance of the operation pattern as user interface;

FIG. 9 is a front view illustrating the operation pattern of one preferred embodiment;

FIG. 10 is a flow chart illustrating an analyzing process of a simple analyzing mode;

FIG. 11 is a flow chart illustrating an analyzing process of a detailed analyzing mode;

FIG. 12 is a flow chart illustrating image conversion processing of another preferred embodiment;

FIG. 13 is a block diagram schematically illustrating a system of one preferred embodiment in which modifying data is transmitted from the order processing computer to the image converting computer;

FIG. 14 is a flow chart illustrating image conversion processing of the system of FIG. 13;

FIG. 15 is a block diagram schematically illustrating a system of one preferred embodiment in which modifying data is transmitted to the camera control computer, image converting computer and image analyzing computer;

FIG. 16 is a flow chart illustrating image conversion processing of the system of FIG. 15;

FIG. 17 is a block diagram schematically illustrating a system of one preferred embodiment in which modifying data is transmitted from the order processing computer to the image analyzing computer; and

FIG. 18 is a flow chart illustrating image conversion processing of the system of FIG. 17.

### DETAILED DESCRIPTION OF THE PREFERRED EMBODIMENT(S) OF THE PRESENT INVENTION

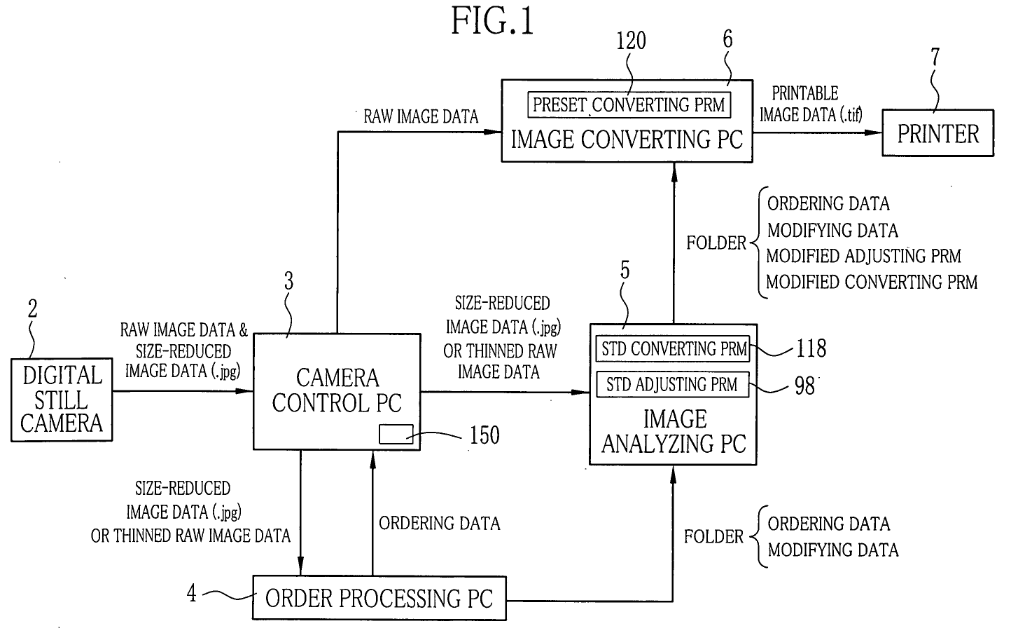

In FIG. 1, an image processing system of the invention is illustrated schematically. The system is used for example in a photo shop or a photo studio of a photographer. The system includes a digital still camera 2, a camera control computer 3, an order processing computer 4, an image analyzing computer 5, an image converting computer 6 and a photographic printer 7. The digital camera 2 is an image pickup device used in the studio, for picking up images related to a customer, for example portraits. The camera control computer 3 or personal computer (PC) controls the digital camera 2, and also is used to store image data produced by the digital camera 2 and transfer the same to other computers. The order processing computer 4 or personal computer (PC) receives the transmitted image data from the camera control computer 3, and is used for accepting customer orders of a customer for producing prints. The image analyzing computer 5 or personal computer (PC) analyzes images related to the customer orders to acquire high image quality of prints by use of the image data. The image converting computer 6 or personal computer (PC) is printable image data generator, and produces printable image data for the purpose of printing. The printer 7 as image forming apparatus produces prints in response to inputs of the printable image data.

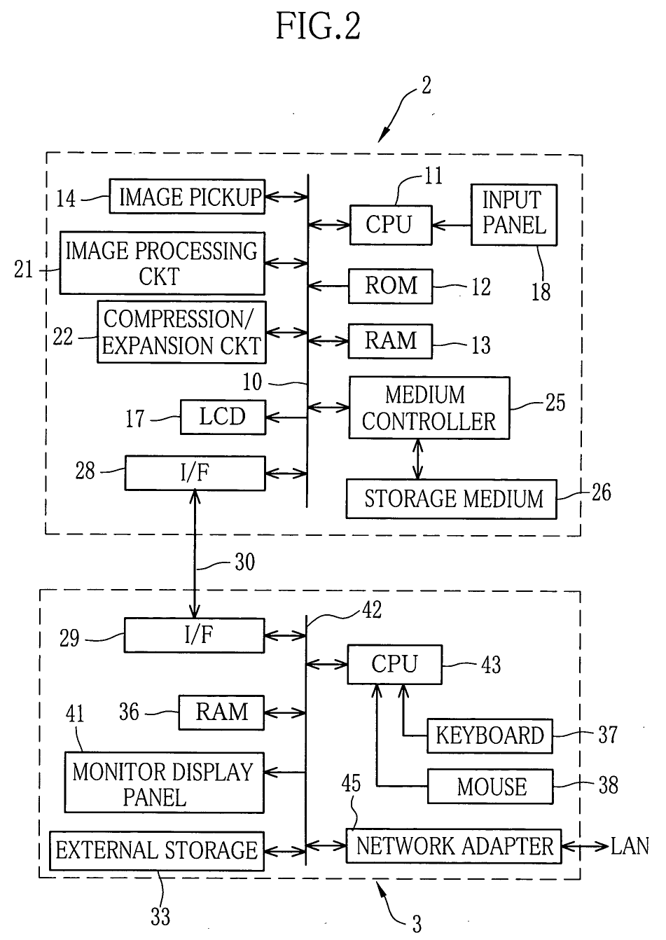

In FIG. 2, constructions of the digital camera 2 and the camera control computer 3 are schematically illustrated. A data bus 10 connects circuit elements in the digital camera 2 with one another. A CPU 11 controls the entirety of the operation. ROM 12 is incorporated to store a program for operating the digital camera 2. An image pickup device 14 includes a photographing lens, CCD (charge coupled device) and the like well-known in the art of image pickup, and produces image data of a digital form by photoelectrically converting an image of an object.

A liquid crystal display panel (LCD) 17 as user interface displays a menu pattern with photographing parameters such as aperture stop, shutter speed and the like. An input panel 18 includes various buttons, keys or the like. A user or photographer views the menu pattern in the LCD 17 and at the same time actuates the input panel 18 by depression. Note that the LCD 17 is an electronic viewfinder at the time of the image pickup mode, and also is used as a playback display for stored images at the time of playback mode.

There is a RAM 13 to which image data from the image pickup device 14 is written and buffered. This image data or output of the image pickup device 14 is CCD-RAW data or raw image data without being corrected for white balance or the like, and is constituted by a data group of numerous pixels with gradation values of 12-bit or 16-bit gradation for each of the colors.

An image processing circuit 21 receives the raw image data or unprocessed image data, subjects the same to various types of processing, such as white balance (WB) processing and gradation converting processing in a state conditioned for discrete product type of the digital still camera 2, in order to output image data after the image correction. A compression/expansion circuit 22 compresses the corrected image data in a format according to JPEG, to produce JPEG image data.

The digital camera 2 is so constructed that formats of image data as outputs can be selected. For example, only raw image data can be output at one time. Only JPEG image data can be output at one time. Also, raw image data and size-reduced image data can be output simultaneously, wherein the size-reduced image data may be JPEG image data or bit map data. For this simultaneous outputting, raw image data is converted into size-reduced image data, and also is thinned if desired. According to this, the size-reduced image data has 1,280×960 pixels.

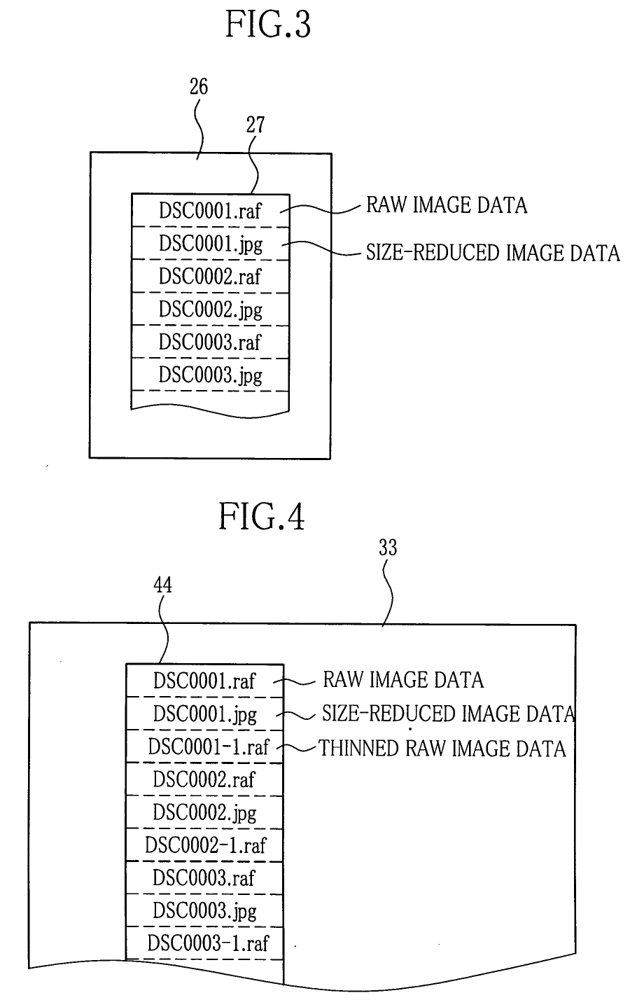

In FIG. 3, a medium controller 25 writes raw image data and size-reduced image data to a storage medium 26 in an image folder 27. The raw image data has a file name of DSC0001.raf. The size-reduced image data at the same time as the raw image data has a file name of DSC0001.jpg, which is different from that of the former only in the extension. It is possible for users to find the association between those by comparing the file names with one another.

An interface channel (I/F) 28 is incorporated in the digital camera 2. An interface channel (I/F) 29 is incorporated in the camera control computer 3. A communication cable 30 connects the interface channel 28 to the interface channel 29. Various data are transmitted and received between the digital camera 2 and the camera control computer 3, including the raw image data, size-reduced image data, and image pickup control data produced by the camera control computer 3 upon conditioning the digital camera 2. Examples of the interface channels 28 and 29 are USB (universal serial bus), and such according to the IEEE 1135. Note that it is possible to use a wireless communication device for transmitting and receiving data with a radio wave in place of the communication cable 30.

The raw image data and size-reduced image data written to the storage medium 26 is transmitted from the digital camera 2 to the camera control computer 3 in response to a command signal in the digital camera 2 or the camera control computer 3. Consequently, images can be picked up consecutively one after another even if the storage medium 26 has rather a small capacity in the digital camera 2. Note that it is also possible to transfer the data directly to the camera control computer 3 without storing in the storage medium 26 after production of the raw image data and size-reduced image data in the digital camera 2. This is possible according to a setting or modification of the camera control program installed in the camera control computer 3, to be described later in detail.

An example of the camera control computer 3 is a general-purpose personal computer. An external storage device 33 is a hard disk drive or the like, and stores operating system (OS) for basically controlling the camera control computer 3, and has various programs installed therein, the programs including a camera control program for controlling the digital camera 2, and a thinned raw image data producing program for producing thinned raw image data in the camera control computer 3 as thinned raw image data generator.

When a power source for the camera control computer 3 is turned on, the operating system (OS) stored in the external storage device 33 is loaded and transmitted to a RAM 36. Thus, the camera control computer 3 starts up. There are a keyboard 37 and a mouse 38, any of which can be operated to start the camera control program. Then the camera control program is transmitted to the RAM 36 and is run. The thinned raw image data producing program is started upon the start of the camera control program in the camera control computer 3.

A monitor display panel 41 as user interface is incorporated in the camera control computer 3. The size-reduced image data are input to the camera control computer 3 by the digital camera 2. The camera control program is run in the camera control computer 3, so that images of the size-reduced image data are displayed on the monitor display panel 41. Also, the camera control computer 3 responds to command signals generated by means of the keyboard 37 and the mouse 38, to determine a setting of the digital camera 2 and control the same. A data bus 42 connects various circuit elements in the camera control computer 3 with one another. A CPU 43 controls those in a comprehensive manner. The raw image data and size-reduced image data from the digital camera 2 are transmitted by the interface channel 29 and the data bus 42, and written to the external storage device 33.

Various operation modes are preset according to the camera control program. For example, there is a PC control mode for controlling the digital still camera 2 with the camera control computer 3, to determine an image pickup condition, to release a shutter, and to store image data in the camera control computer 3. A standard camera control mode is for determining an image pickup condition in the digital camera 2, to release the shutter, and to store image data in the storage medium 26. Also, an extended camera control mode is for determining an image pickup condition in the digital camera 2, to release the shutter, and to store image data in the camera control computer 3.

The thinned raw image data producing program is run in response to receiving raw image data, to thin a pixel signal at a regular proportion and regular interval from pixel signals of the raw image data, so as to produce thinned raw image data. As depicted in FIG. 4, the thinned raw image data is written to a location in an image folder 44 of the external storage device 33 together with the raw image data and size-reduced image data. A file of the thinned raw image data is given a file name of, for example, DSC0001-1.raf, in association with a file name DSC0001.raf of the raw image data.

A network adapter 45 is incorporated in the camera control computer 3, and connects the main unit of the camera control computer 3 with the LAN (local area network). Each of the order processing computer 4, the image analyzing computer 5 and the image converting computer 6 is a personal computer of a general-purpose type similar to the camera control computer 3. Those are connected with the LAN by a network adapter.

As the camera control program executes in the camera control computer 3, a mode selector 150 is constituted as an element included in the camera control computer 3. The mode selector 150 operates to set a selected one of a simple analyzing mode and a detailed analyzing mode. When the simple analyzing mode is set, size-reduced image data is used in subsequent steps of acceptance of a customer order, image analysis and image conversion. When the detailed analyzing mode is set, thinned raw image data is used in the subsequent steps.

The simple analyzing mode is used typically in an environment having small changes with time, for example inside a photo studio, and is adapted to image adjustment in a small range for the color balance, brightness and contrast. The detailed analyzing mode is used typically in an environment with large changes, for example, where the number of persons to be photographed, lighting and the like changes considerably even inside a photo studio. Detailed adjustment is possible for the tone curve, white balance, exposure correction, and other image correction, in addition to the simple image adjustment of the color balance, brightness and contrast. This is also advantageous for use in an instant studio of a simple structure without repeated use, and the like.

When simple analyzing mode is selected, the camera control program causes transmission of size-reduced image data to the order processing computer 4 and the image analyzing computer 5, and transmission of the raw image data to the image converting computer 6. When detailed analyzing mode is selected, thinned raw image data is transmitted to the order processing computer 4 and the image analyzing computer 5. Raw image data is transmitted to the image converting computer 6. The above-described thinned raw image data producing program is run only when the detailed analyzing mode is selected. Note that a basic construction of the computers 4-6 is the same as that of the camera control computer 3. No further basic description will be made.

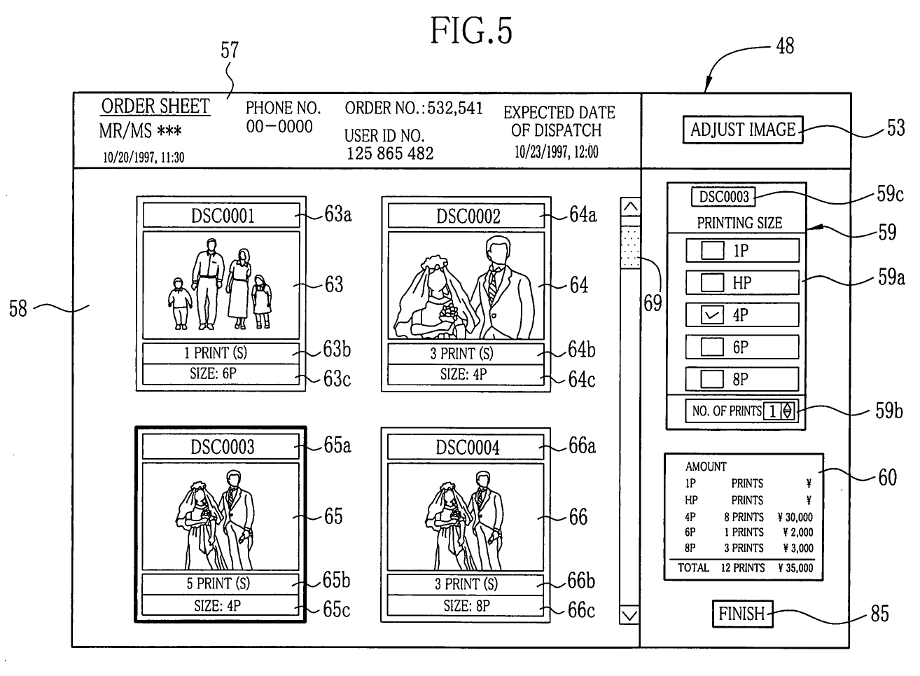

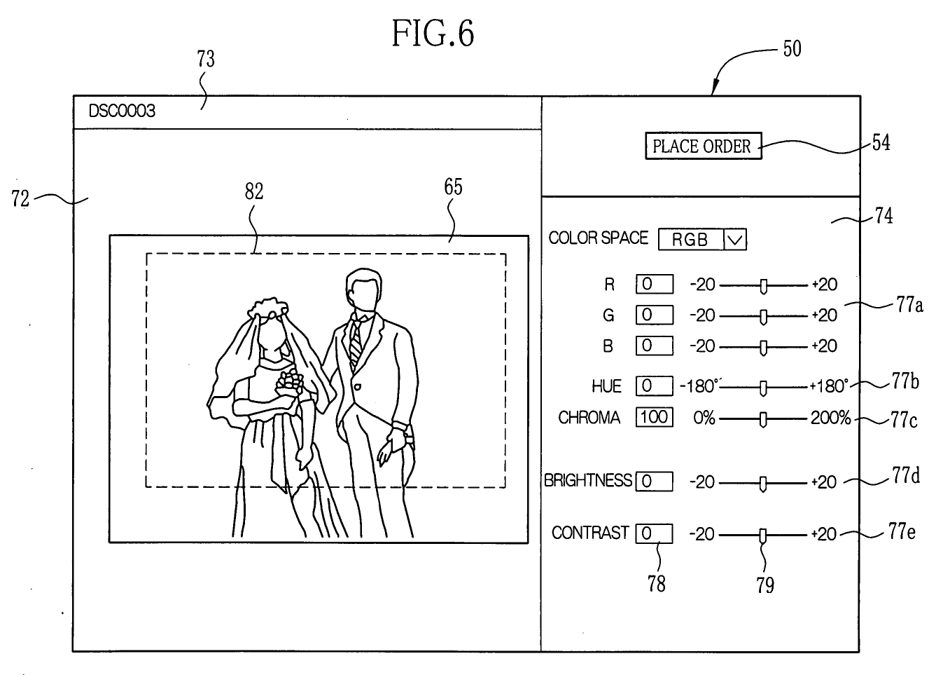

An order processing program is installed in the external storage device of the order processing computer 4, for the process including browsing recorded images, and selecting prints related to an order by consulting for a customer. In FIGS. 5 and 6, there are an order processing pattern 48 and an image adjusting pattern 50 or screen patterns displayed on a display panel by running the order processing program. The order processing pattern 48 displays a list of plural images of image data input by the camera control computer 3. The image adjusting pattern 50 displays an enlarged form of a selected one of the images in the order processing pattern 48. To input command signals for changing over, the mouse and keyboard are used suitably.

The order processing program is run in a selected one of two modes which are a size-reduced image ordering mode and a thinned image ordering mode. When the size-reduced image ordering mode is set, a customer order for prints produced by size-reduced image data is accepted. When the thinned image ordering mode is set, a customer order for prints produced by thinned raw image data is accepted. The selection of those modes is automatically made by considering the format of the image data output by the camera control computer 3, namely by discernment of one of size-reduced image data and thinned raw image data.

The order processing program is run in response to receiving size-reduced image data from the camera control computer 3, to display an image of the size-reduced image data on the order processing pattern 48 by playing back. If thinned raw image data is received from the camera control computer 3, the thinned image data is subjected to image conversion according to predetermined set of initial parameters, to output thinned printable image data of a file of the TIFF (Tagged Image File Format) format having gradation of 16 bits for each of the colors. The thinned printable image data is played back for display in the order processing pattern 48. A file of the thinned printable image data is given a file name of, for example, DSC0001-1.tif, in association with a file name DSC0001-1.raf of the thinned raw image data.

Note that a term of pre-conversion is used herein to mean processing of image conversion of thinned raw image data to produce thinned printable image data. A term of main conversion is used herein to mean processing of image conversion of raw image data to produce printable image data.

The order processing pattern 48 and the image adjusting pattern 50 are selective patterns, only one of which is displayed at one time. While the order processing pattern 48 is displayed, an image adjusting button 53 is indicated in the order processing pattern 48 at an upper corner. When the image adjusting button 53 is clicked by use of the mouse, the image adjusting pattern 50 appears responsively in place of the order processing pattern 48. In turn, while the image adjusting pattern 50 is displayed, a print ordering button 54 is indicated in the image adjusting pattern 50 at an upper corner. When the print ordering button 54 is clicked by use of the mouse, the order processing pattern 48 appears responsively in place of the image adjusting pattern 50.

The order processing pattern 48 includes an information display region 57, an image display region 58, an ordering data generating region 59 for print designating, and an amount display region 60. The information display region 57 indicates various items including a customer name, a telephone number of the customer, his or her user ID number, order number, ordering date and estimated date of dispatch. If a customer places the order for the first time, his or her name, telephone number, user ID and other information are input newly. If a customer places the order repeatedly after the first order, his or her personal information is read from the order processing computer 4 in information of a customer database.

In the image display region 58, images 63, 64, 65 and 66 of either size-reduced image data (JPEG) or thinned raw image data are displayed as inputs from the camera control computer 3. There are file name areas 63a, 64a, 65a and 66a, disposed higher than the images 63-66, for indicating partial file names, which are portions of the file names before the extensions. Number-of-print areas 63b, 64b, 65b and 66b under the images 63-66 indicate numbers of prints. Size indicating areas 63c, 64c, 65c and 66c under the images 63-66 indicate printing sizes.

For the purpose of placing an order for prints, one of the images, for example the image 65, is clicked and selected by means of a mouse as a pointing device. Thus, it is easy to discern the selected image owing to the higher density of a frame about the image 65. A scroll bar 69 is indicated to extend between the image display region 58 and the ordering data generating region 59, to scroll the shape of the image display region 58. This makes it possible to view four or more images.

The ordering data generating region 59 includes a size selection area 59a and a number-of-print input area 59b. The size selection area 59a is used for designating a selected one of various printing sizes, such as 1P, HP, 4P, 6P and 8P. The number-of-print input area 59b is used for inputting the number of prints to be requested. A file name area 59c appears in an upper portion of the ordering data generating region 59, and indicates a file name of the selected one of plural images. The amount display region 60 indicates a list of input printing sizes and the numbers of prints, and an amount billed which is obtained automatically by calculation according to values in the list.

When one image in the image display region 58 is clicked by double clicking, the image adjusting pattern 50 in FIG. 6 is caused to appear. Also, when the image adjusting button 53 is clicked after one image in the image display region 58 is clicked and selected, the image adjusting pattern 50 in FIG. 6 is caused to appear. The image adjusting pattern 50 includes a large display region 72, a title bar 73, and an image adjusting region 74. The large display region 72 indicates the image 65 in an enlarge manner according to the selection. The title bar 73 indicates a file name of the image displayed in the large display region 72.

Various input bars 77a, 77b, 77c, 77d and 77e are displayed in the image adjusting region 74, for changing various items, such as color balance, brightness and contrast. For setting a value at each of the input bars 77a-77e, an input box 78 can be used for directly inputting a numerical value. Also, a pointer or indicator 79 can be shifted horizontally to the right or left. The order processing program subjects size-reduced image data of the image 65 or thinned printable image data to image adjustment according to the setting input by the input bars 77a-77e. The image 65 of the size-reduced image data is displayed on the large display region 72 after the image adjustment. Thus, the image can be adjusted by an attendant together with a customer observing the adjusted result.

A trimming frame 82 is indicated over the image 65 in the large display region 72. The size of the trimming frame 82 is changed by use of the mouse, to designate a region to be printed. Note that a length-to-width ratio of the trimming frame 82 can be changed according to an aspect ratio of a printing size selected in the order processing pattern 48, or may be changeable in a continuous manner as a user desires.

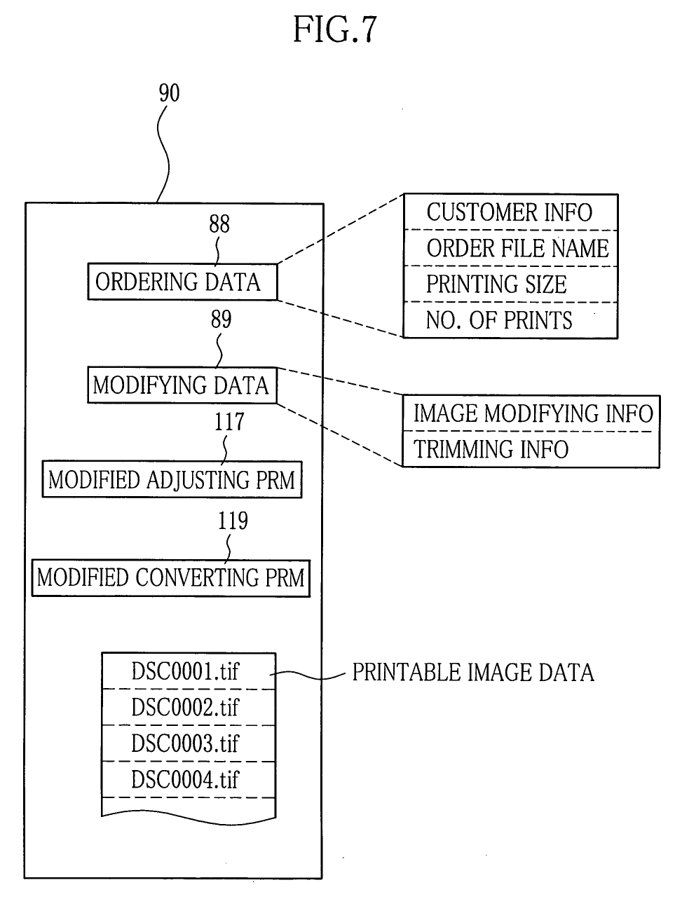

A finish button 85 in a lower portion of the order processing pattern 48 is clicked upon the finish of placing of the customer order. In FIG. 7, ordering data 88 is produced by combining customer information, file names of images related to the customer order, and the number of prints and the printing size of the images. Also, modifying data 89 is produced according to image adjusting information and trimming information for the respective images. The trimming information constitutes quality modifying preference information. An ordering data folder 90 is produced, in which the ordering data 88 and the modifying data 89 are sorted and written, before the ordering data folder 90 is transmitted to the image converting computer 6. Also, the ordering data 88 is used for renewing the customer database stored in the order processing computer 4.

Furthermore, the ordering data 88 is transmitted to the camera control computer 3. The camera control computer 3 upon receiving the ordering data 88 transmits a portion of raw image data or unprocessed image data to the image converting computer 6, the portion being associated with the customer order. Therefore, load in the processing in each of the computers can be decreased in the data transfer, because the amounts of transmitted data in the LAN installed in the photo studio is reduced. Note that portions of raw image data which are not related to customer orders can be deleted from the camera control computer 3 at this time.

The external storage device of the image analyzing computer 5 stores the analyzing program installed therein for analyzing the size-reduced image data input from the camera control computer 3. The analyzing program is run for adjusting a converting parameter and adjusting parameter, the converting parameter being used to convert the raw image data into printable image data, the adjusting parameter being used for image adjustment of the printable image data.

The image analyzing program is run in a selected one of two modes which are a size-reduced image analyzing mode and a thinned image analyzing mode. Those modes correspond to the simple and detailed analyzing modes of the camera control program. When the size-reduced image analyzing mode is set, an image is analyzed by use of size-reduced image data. When the thinned image analyzing mode is set, an image is analyzed by use of thinned raw image data. The selection of those modes is automatically made by considering the format of the image data output by the camera control computer 3, namely by discernment of one of size-reduced image data and thinned raw image data.

When size-reduced image data is transmitted from the camera control computer 3, the analyzing program is run to display images of the size-reduced image data in a minimized form on the display panel, to analyze the images. When thinned raw image data is transmitted from the camera control computer 3, the analyzing program is run to subject the thinned raw image data to pre-conversion, to produce thinned printable image data of the Tiff format having 16-bit gradation for each of the colors. The images are analyzed by use of the thinned raw image data.

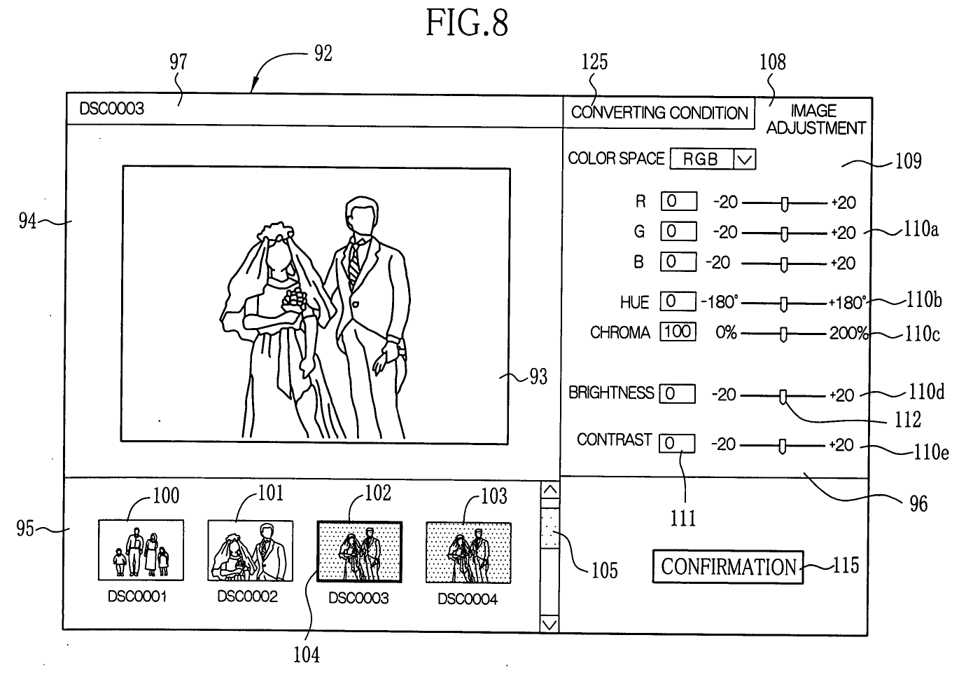

In FIG. 8, an image analyzing screen pattern 92 is displayed on the display panel for the image analyze pattern. The image analyzing screen pattern 92 includes an analyzing display region 94, a size-reduced display region 95, and a parameter (PRM) modifying region 96. The analyzing display region 94 displays an image 93 of either of size-reduced image data or thinned printable image data to be analyzed. A title bar 97 is displayed in an upper portion of the analyzing display region 94 and indicates a file name or title of the image 93.

In the size-reduced image analyzing mode, the image analyzing program uses a standard adjusting parameter (PRM) 98. The size-reduced image data is received from the camera control computer 3, and is subjected to the image adjustment according to the standard adjusting parameter 98 and the modifying data 89. Thus, it is possible to reflect ideas of a customer to the side-reduced image data used in the analysis, so as to satisfy his or her desire in the form of the adjustment. The size-reduced image data after the image adjustment is output, so size-reduced images 100, 101, 102 and 103 of a data file in the JPEG (Joint Photographic Coding Expert Group) format are displayed in the size-reduced display region 95. A desired one of the size-reduced images 100-103 can be selected in the size-reduced display region 95, and becomes displayed in the analyzing display region 94 as the image 93.

In the example, four size-reduced images are displayed in the size-reduced display region 95. However, the number of images observable at one time can be increased or decreased by a suitable setting. A selection cursor 104 is displayed in a highlighted manner about the third size-reduced image 102 associated with the image 93, to make the association of the third size-reduced image 102 distinct. A scroll bar 105 is disposed in a right lateral portion of the size-reduced display region 95 and is movable in a scrolled manner up and down. If five or more size-reduced images are displayed, the scroll bar 105 is slid up or down, so more than five images can be viewed.

Some of the size-reduced images 100-103 in the size-reduced display region 95 are indicated in black and white appearance if analysis is required. In the drawing, the size-reduced images 102 and 103 are indicated in black and white appearance. In contrast, the remainder of the size-reduced images 100-103 in the size-reduced display region 95 are indicated in a full-color manner if analysis is unnecessary or has been made. In the example, the second size-reduced image 101 has been analyzed. The first size-reduced image 100 is not related to the customer order but excluded from the analysis.

The PRM modifying region 96 is changeable between two screen patterns or regions by clicking a selected one of two upper selection tabs, which are an image adjustment tab 108 and a converting condition tab 125. The image adjustment screen pattern is used to modify the standard adjusting parameter 98. The converting condition screen pattern is used to modify the converting parameter. When the image adjustment tab 108 is clicked, an image adjusting table 109 is caused to appear in the PRM modifying region 96.

Various input bars 110a, 110b, 110c, 110d and 110e are displayed in the image adjusting table 109, for changing the standard adjusting parameter 98 of plural items, such as color balance, brightness and contrast. For setting a value at each of the input bars 110a-110e, an input box 111 can be used for directly inputting a numerical value, in a manner similar to the order processing computer 4. Also, a pointer or indicator 112 can be shifted horizontally to the right or left. The standard adjusting parameter 98 is changed by setting the input bars 110a-110e. The size-reduced image data of the image 93 is subjected to image adjustment according to the setting input by the input bars 110a-110e. The image 93 of the size-reduced image data is observable in the analyzing display region 94 after the image adjustment.

Various items are adjusted by checking the image 93. A confirmation button 115 is clicked after the adjustment is made finally. Then a modified adjusting parameter (PRM) 117 is produced to represent the adjustment made by the analysis. In FIG. 7, the modified adjusting parameter 117 is written to a location in the ordering data folder 90 as file data. When all of images to be printed are analyzed finally, the ordering data folder 90 is transmitted to the image converting computer 6.

If the image analyzing program is run in the thinned image analyzing mode, a standard converting parameter (PRM) 118 preset in the program is considered to subject the thinned raw image data to pre-conversion, so that thinned printable image data is produced. An image of the thinned printable image data is displayed in the size-reduced display region 95 of the image analyzing screen pattern 92 for the image analyzing program. An image selected by the size-reduced display region 95 is displayed in the analyzing display region 94 as the image 93.

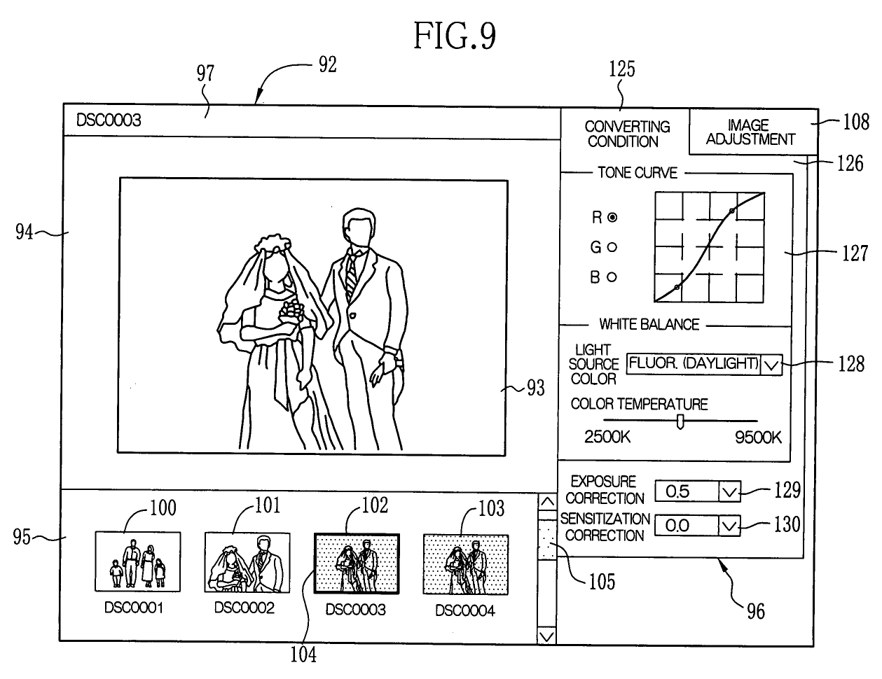

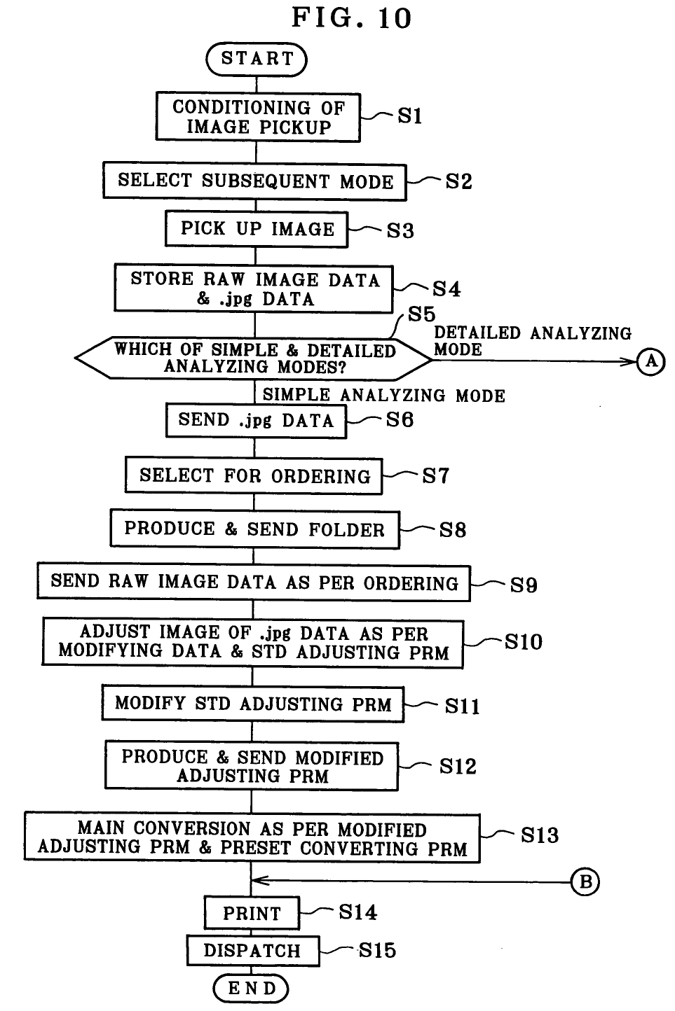

In the thinned image analyzing mode, at first the standard converting parameter 118 used in the pre-conversion is modified. When the converting condition tab 125 is clicked selectively in FIG. 8, a condition changing table 126 is displayed as illustrated in FIG. 9. The condition changing table 126 has a tone curve changing area 127, a white balance (WB) correction area 128, an exposure correction box 129, and a sensitization correction box 130. The WB correction area 128 is adapted to correction of a color light source, color temperature or the like. The condition changing table 126 is accessed by pointing of the mouse, to modify the standard converting parameter 118.

The standard converting parameter 118 is modified into a modified converting parameter (PRM) 119, according to which pre-conversion of the image is effected. The thinned printable image data after the pre-conversion is displayed by way of the image 93. Thus, it is possible to modify the standard converting parameter 118 while a result of the pre-conversion is observed and checked for satisfaction of intentions of a customer.

Then thinned printable image data after pre-conversion by means of the modified converting parameter 119 is subjected to image adjustment on the basis of the modifying data 89 and the standard adjusting parameter 98. In a similar manner to the size-reduced image analyzing mode, the standard adjusting parameter 98 is modified, to produce the modified adjusting parameter 117. The modified converting parameter 119 and the modified adjusting parameter 117 are written to locations in the ordering data folder 90 as file data, and transmitted to the image converting computer 6.

Note that examples of the converting parameters can include sharpness correction parameters or the like in addition to parameters of the tone curve and white balance depicted in FIG. 9. The modifying parameters may include trimming correction parameter in addition to those depicted in FIG. 7. Furthermore, any combination of a converting parameter and a modifying parameter may be suitably determined and used. For example, a color balance correction parameter may be included as a converting parameter.

An image converting program is installed in an external storage device of the image converting computer 6, and is run to subject raw image data from the camera control computer 3 to main conversion, so as to produce printable image data. The printable image data is for example image data of the TIFF format, and can be used for displaying an image in a personal computer and printing in a printer. Definition or resolution of the image is maintained as that of the raw image data even when the image data is converted.

The image converting program is run in a selected one of two modes which are a size-reduced image converting mode and thinned image converting mode, and are associated with the simple and detailed analyzing modes in the camera control program. For changing over the modes, the type of the parameters in the ordering data folder 90 transmitted from the image analyzing computer 5 is discerned to change the modes automatically.

If, for example, only the modified adjusting parameter 117 is stored at a location in the ordering data folder 90, then the size-reduced image converting mode is set so as to indicate image analysis by means of size-reduced image data. In the size-reduced image converting mode, the data is subjected to the main conversion according to a preset converting parameter (PRM) 120 and the modified adjusting parameter 117. Note that the preset converting parameter 120 is preset for a particular environment of pickup, for example a photo studio, and is stored in the external storage device, and is read at the time of image conversion. Since the preset converting parameter 120 being used is optimized for a photo studio having small changes in the environment, the modification of the preset converting parameter 120 in the analyzing process can be omitted in the analyzing operation. Thus, efficiency of analysis can be high.

If the modified adjusting parameter 117 and the modified converting parameter 119 are stored at locations in the ordering data folder 90, then the thinned image converting mode is set for the information that the image analysis has been made according to the thinned raw image data. In the thinned image converting mode, the main conversion is made according to the modified converting parameter 119 and the modified adjusting parameter 117.

The printable image data produced by image conversion of the raw image data is stored at a location in the ordering data folder 90 with a new extension of .tif without change of a file name portion before the extension. Consequently, all data related to image pickup of a particular customer become stored at a location in the ordering data folder 90. It is possible to handle an extra customer order for reprinting or the like. Then the printable image data is output by the image converting computer 6 to the printer 7, which produces prints in a determined size and determined number of prints.

A flow chart of FIG. 10 is referred to next, to describe a process of the image processing system of the invention. At the step S1, the digital still camera 2 or the camera control computer 3 is operated to condition the image pickup of the digital camera 2. In the camera control computer 3, one of predetermined modes to be used subsequently is selected at the step S2, for example, acceptance of customer orders, image analysis, image conversion and the like. Operation in the selection of the simple analyzing mode will be described next.

In the condition for the image pickup, a customer is photographed by the digital camera 2 in the photo studio, to produce raw image data or unprocessed image data, together with size-reduced image data at the step S3. The raw image data and size-reduced image data are written to the external storage device 33 of the camera control computer 3 at the step S4 through elements in the interface channels 28 and 29 and the communication cable 30. If the raw image data and size-reduced image data are stored in the storage medium 26, those will be transmitted to the external storage device 33 by subsequent operation of the digital camera 2 or the camera control computer 3. The camera control program is run in the camera control computer 3 in the simple analyzing mode. See the step S5. Thus, the size-reduced image data is transmitted to the order processing computer 4 and the image analyzing computer 5 at the step S6.

The order processing computer 4 runs to show the order processing pattern 48 of FIG. 5 for the order processing program, and accepts a customer order for printing of images. Also, the order processing computer 4 shows the image adjusting pattern 50 of FIG. 6 at the step S7, for effecting image adjustment desired by a customer. According to the customer order, the ordering data 88 and the modifying data 89 are produced, and transmitted to the image analyzing computer 5 in a form with the ordering data folder 90 at the step S5. Therefore, it is possible to accept a customer order immediately after the completion of the image pickup, as the size-reduced image data is used for accepting customer orders. No waiting is required for image conversion. In the course of accepting a customer order, it is possible to adjust the image as desired by the customer.

The ordering data 88 is also transmitted to the camera control computer 3. Part of the raw image data corresponding to images related to the customer order are transmitted by the camera control computer 3 to the image converting computer 6 at the step S9. This is advantageous in reduced load to each computer in the data transfer, because raw image data to be transmitted is prevented from having an extremely great size.

The image analyzing computer 5 subjects size-reduced image data to image adjustment according to the modifying data 89 from the order processing computer 4 and the standard adjusting parameter 98 preset therein. At the step S10, the image analyzing computer 5 causes the size-reduced display region 95 to display adjusted images of the size-reduced image data in a listed manner. Therefore, images can be analyzed well in consideration of intentions of the customer. Size-reduced images in the size-reduced display region 95 are indicated in a full-color manner if analysis is unnecessary or has been made, but indicated in black and white appearance if analysis is required. This makes it easy to discern size-reduced image data of which analysis is required.

An image selected in the size-reduced display region 95 by an operator is displayed in the analyzing display region 94 in an enlarged manner of the image 93. The operator accesses the input bars 110a-110e in the image adjusting table 109, to adjust the standard adjusting parameter 98 of the image 93 at the step S11. Then the size-reduced image data associated with the image 93 are subjected to image adjustment by means of the standard adjusting parameter 98 being modified. An image obtained by the adjustment is displayed in the analyzing display region 94 in a renewed manner. When the image comes to have appearance desired by the operator, the adjustments finishes. After this, the confirmation button 115 is clicked. The modified adjusting parameter 117 representing this image adjustment is produced, and is written to a location in the ordering data folder 90, which is transmitted to 6 at the step S12.

The image converting computer 6 specifies raw image data of an image to be printed according to the ordering data 88, and subjects the raw image data to image conversion at the step S13 in consideration of the modified adjusting parameter 117 and the preset converting parameter 120. Thus, printable image data are produced by the image conversion, and become stored in the ordering data folder 90. The printable image data is output by the image converting computer 6 to the printer 7, so as to produce prints at the input number and printing size at the step S14. Prints being obtained are dispatched together with an invoice or check to the customer. See the step S15.

This being so, the converting parameter customized for the photo studio with a certain environment is used. Operation for modification of the converting parameter can be unnecessary, to raise efficiency in the analysis. Furthermore, size-reduced image data can be used in the analysis owing to the lack of adjustment of the converting parameter. Thus, the analysis can be made immediately after the image pickup. Also, no image conversion is required in the analysis. Time for the analysis can be small.

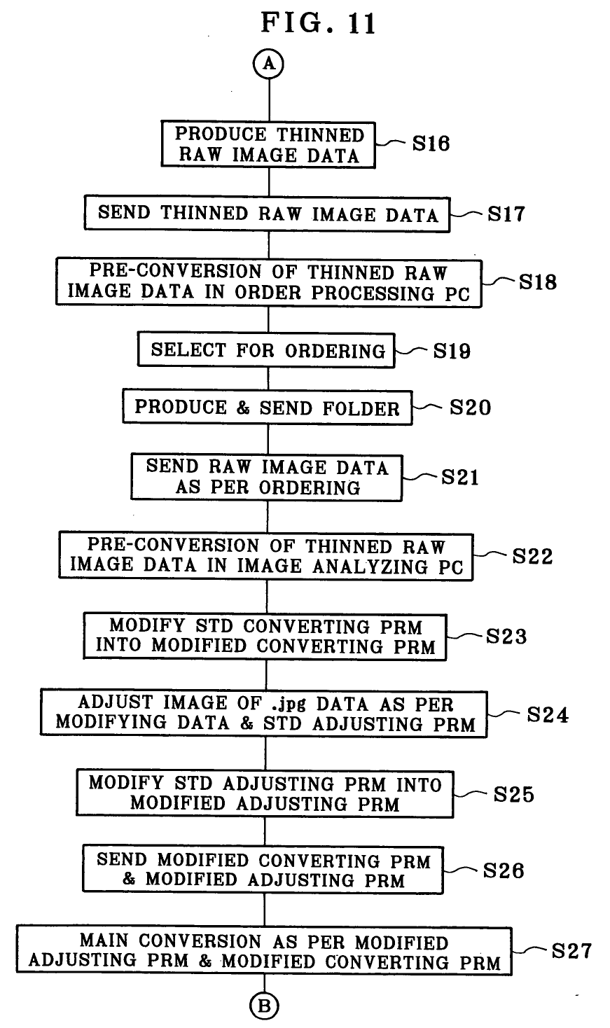

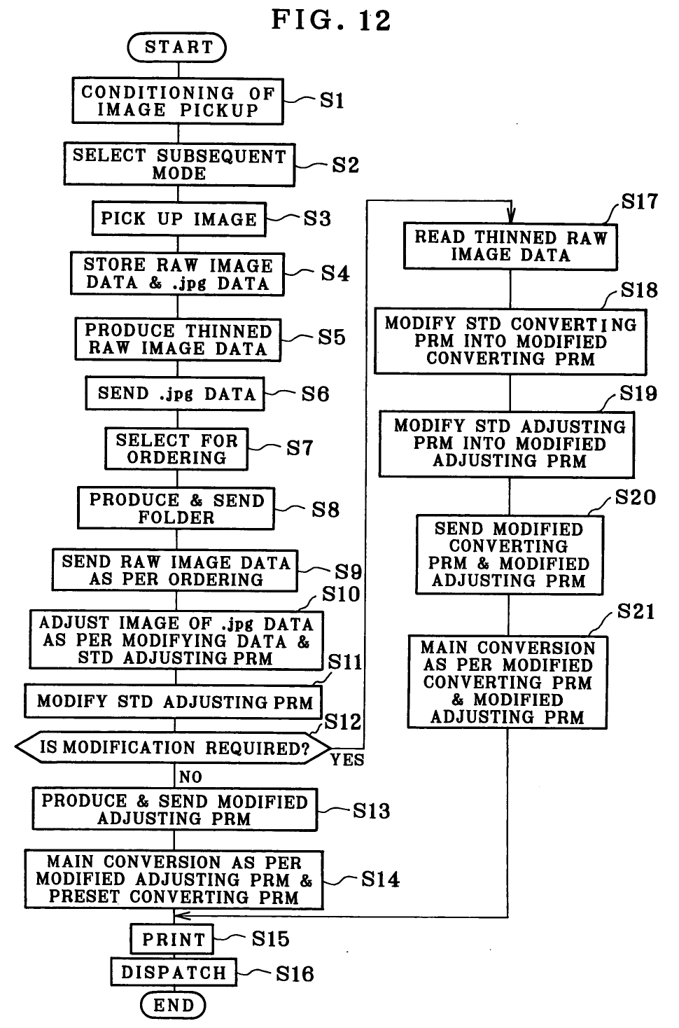

A flow chart of FIG. 11 is referred to next, to describe operation in the selection of the detailed analyzing mode as a subsequent mode of the camera control computer 3. At the step S2, raw image data is produced, and written to the camera control computer 3 at the step S4. At the step S16, the program for producing the thinned raw image data is run, to produce the thinned raw image data. The camera control computer 3 transmits the thinned raw image data to the order processing computer 4 and to the image analyzing computer 5 at the step S17.

The order processing computer 4 subjects the received thinned raw image data to the pre-conversion, to produce thinned printable image data at the step S18. The order processing pattern 48 of FIG. 5 according to the order processing program is accessed, to process a customer order for printing of images. The image adjusting pattern 50 of FIG. 6 is accessed, to set image adjustment in consideration of the customer at the step S19. According to the customer order, the ordering data 88 and the modifying data 89 are produced, and written to locations in the ordering data folder 90, and transmitted to the image analyzing computer 5 at the step S20. The camera control computer 3 is responsive to the ordering data, and transmits the raw image data to the image converting computer 6 at the step S21.

The image analyzing computer 5 subjects the thinned raw image data to pre-conversion by use of the standard converting parameter 118, to produce thinned printable image data at the step S22. Then the standard converting parameter 118 is modified according to the condition changing table 126 illustrated in FIG. 9, to produce the modified converting parameter 119 at the step S23. At the step S24, the thinned displayed image data after the pre-conversion with the modified converting parameter 119 is subjected to image adjustment by means of the modifying data 89 and the standard adjusting parameter 98. At the step S25, the modified adjusting parameter 117 is produced by modifying the standard adjusting parameter 98. The modified converting parameter 119 and the modified adjusting parameter 117 become stored in the ordering data folder 90 as file data, and are transmitted to the image converting computer 6 at the step S26.

The image converting computer 6 specifies raw image data according to the ordering data 88 for images to be printed, and subjects the raw image data to the image conversion by means of the modified adjusting parameter 117 and the modified converting parameter 119 at the step S27. The printable image data produced by the conversion is written to a location in the ordering data folder 90. The printable image data is output by the image converting computer 6 to the printer 7. Prints are produced at the step S14 in the designated size and at the designated number of prints. The finished prints are dispatched together with an invoice or check to a customer at the step S15.

The subsequent modes are selected at the start of the image pickup. If the environment of the image pickup is different from that used normally, the converting parameter can be modified by use of the thinned raw image data. This is advantageous in the simplicity, because of preventing double operation of the image analysis by use of the size-reduced image data and also adjustment of the converting parameter by use of the raw image data.

In the above embodiment, one of the subsequent modes is selected at the start of image pickup. Thinned raw image data is produced from raw image data only when the detailed analyzing mode is selected. Alternatively, FIG. 12 illustrates another preferred embodiment. After the image pickup, thinned raw image data is produced from raw image data at the step S5. Selection for ordering is made at the steps S7 and S8. Images are analyzed at the steps S10 and S11. If image correction of white balance, exposure and the like is required at the step S12 after the analysis, then thinned raw data predetermined is read at step S17. It is possible to analyze images at steps S18-S21 with possibility of modifying the converting parameter. Consequently, images can be analyzed quickly even if the selection of the subsequent modes is difficult by considering the environment of the image pickup at the start.

Furthermore, it is possible to change the sequence of the steps of the embodiment. For example, at first the image analysis of the size-reduced image data is effected if possible. Secondly, thinned raw image data is produced from the raw image data if the image analysis of the size-reduced image data is not possible. Thirdly and finally, image analysis of the thinned raw image data is effected. In operation, the thinned raw image data can be produced only if analyzing of an image of the thinned image data is found insufficient. It is possible to analyze images and accept orders without waiting for producing of thinned image data even if the number of computers is as small as one or two for composite operation of the camera control, order acceptance, image analysis and image conversion.

Furthermore, it is possible in the digital camera 2 to set a selected one of the subsequent modes. Also, the thinned raw image data may be produced in the digital camera 2. Furthermore, production of size-reduced image data may be suppressed in the digital camera 2 when the detailed analyzing mode is set. Also, transmission of the produced size-reduced image data to the camera control computer 3 may be suppressed.

In the above embodiment, the computers are separate from one another, including the camera control computer 3, the order processing computer 4, the image analyzing computer 5 and the image converting computer 6. However, only one computer may be used by installing the plural programs therein to establish the image processing system. Additionally, plural computers can be used. One or more common programs can be installed into the plural computers, for raising the efficiency of the processing. Also, a first computer for the simple analyzing mode can be separate from a second computer for the detailed analyzing mode. It is possible to operate one of the two computers selectively according to a selected one of the two analyzing modes.

Another preferred embodiment is described by referring to FIG. 10. This is constituted by the flow of FIG. 10 but without the step S5 and without connection with FIG. 11. There is no use of the thinning. Only the simple analyzing mode is used without the detailed analyzing mode.

In the embodiment, there is no modification of the converting parameter in the image analyzing computer 5. This is because a generally popular photo studio is free from great changes in the environment in the image pickup. Efficiency in the analysis is higher if the converting parameter is optimized in the image converting computer 6 for the studio environment than if the image analyzing computer 5 modifies the converting parameter for all of the image data.

The image converting computer 6 receives the ordering data 88 input by the image analyzing computer 5, to specify raw image data or unprocessed image data of an image to be printed, and subjects the raw image data to the image conversion by considering the modified adjusting parameter 117 and the preset converting parameter 120. Note that the image conversion in the image converting computer 6 can be automatic, because no manual handling of an operator is required.

The processing of the present embodiment is described. See FIG. 9. At the step S1, the digital still camera 2 or the camera control computer 3 is operated to determine the pickup condition of the digital camera 2. A portrait image of a customer is photographed by the digital camera 2 in the photo studio according to the condition, to produce raw image data and size-reduced image data at the step S2. The raw image data and size-reduced image data are transmitted by the interface channels 28 and 29 and the communication cable 30, and at the step S3, are written to the external storage device 33 of the camera control computer 3. Note that if the raw image data and size-reduced image data are written to the storage medium 26, those are transferred to the external storage device 33 by subsequent operation of the digital camera 2 or the camera control computer 3.

In the above embodiment, the preset converting parameter 120 as preset information is used in the image converting computer 6 for image conversion of raw image data. However, it is likely in a photo studio that considerable changes occur in the environment due to an increase or decrease in the number of persons to be photographed. This is because lighting and other equipment must be changed or adjusted in considering a different in the number of the persons from a prescribed standard number. The image conversion cannot be appropriate for optimizing the white balance, exposure correction and the like if the preset converting parameter 120 of the preset information is used. Consequently, it is desirable in the image analyzing computer 5 to read raw image data from the camera control computer 3 for images to be printed, and to adjust the converting parameter by running the image analyzing program.

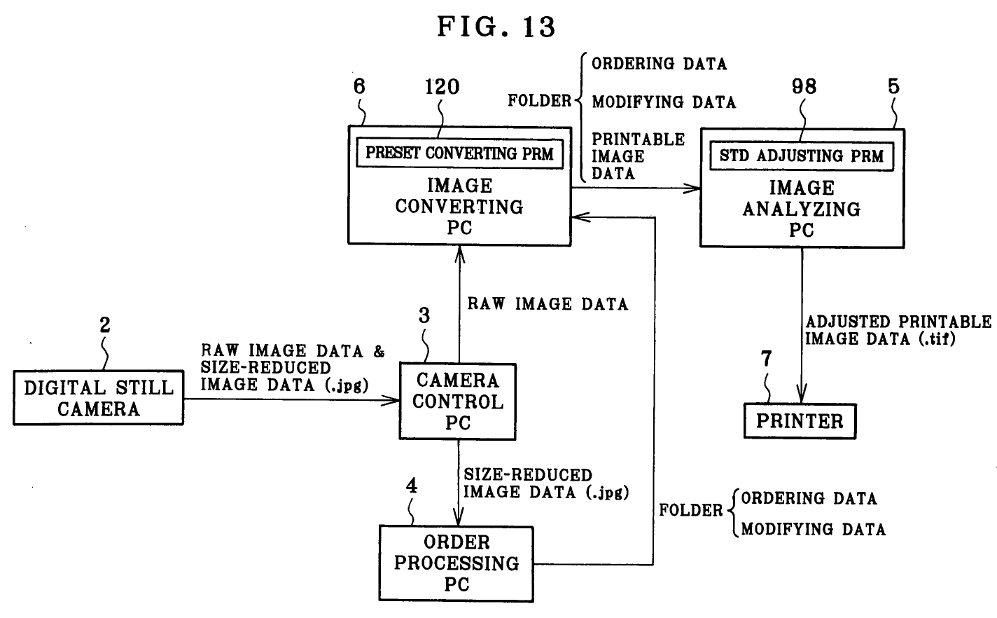

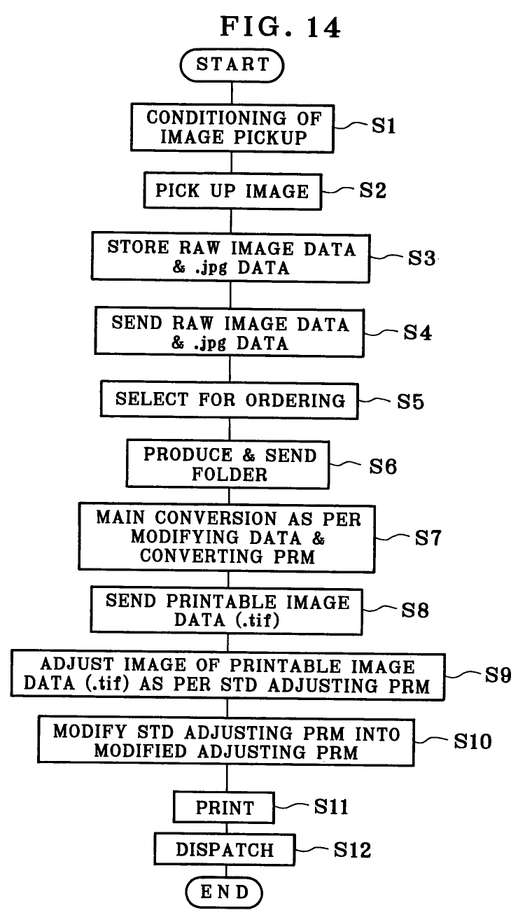

In FIGS. 13 and 14, still another preferred embodiment is illustrated, in which the raw image data is converted in the image converting computer 6 at the step S7 into printable image data, which is adjusted in the image analyzing computer 5 at the step S9.

The preset converting parameter 120 for use in the image conversion in the image converting computer 6 is previously set in consideration of pickup environment of the photo studio. Note that it is very usual to photograph one common person for plural times even in one scene or with the same pose. It is possible to change manually a converting parameter used in a first or second time of the image pickup, to determine a modified converting parameter in the converting operation. The modified converting parameter can be used for the image pickup for the third time and later. The preset converting parameter 120 is written to an external storage device of the image converting computer 6, and if required for the conversion, read and used. Consequently, the analyzing operation does not need adjustment of the preset converting parameter 120 because of the use of the preset converting parameter 120 particularly optimized for the photo studio with small changes in the environment. Efficiency in the analysis can be high.

The camera control computer 3 transmits the size-reduced image data to the order processing computer 4, and the raw image data to the image converting computer 6. The order processing computer 4 processes a customer order by utilizing the size-reduced image data for the purpose of displaying a group of images for selection, without waiting for image conversion. The image converting computer 6 converts the raw image data into printable image data according to a preset converting parameter, which can be useful in automating the image conversion.

In the embodiment of FIGS. 13 and 14, size-reduced image data is used in accepting customer orders. Thus, no time of waiting the image conversion is necessary. It is possible to accept customer immediately after the image pickup.

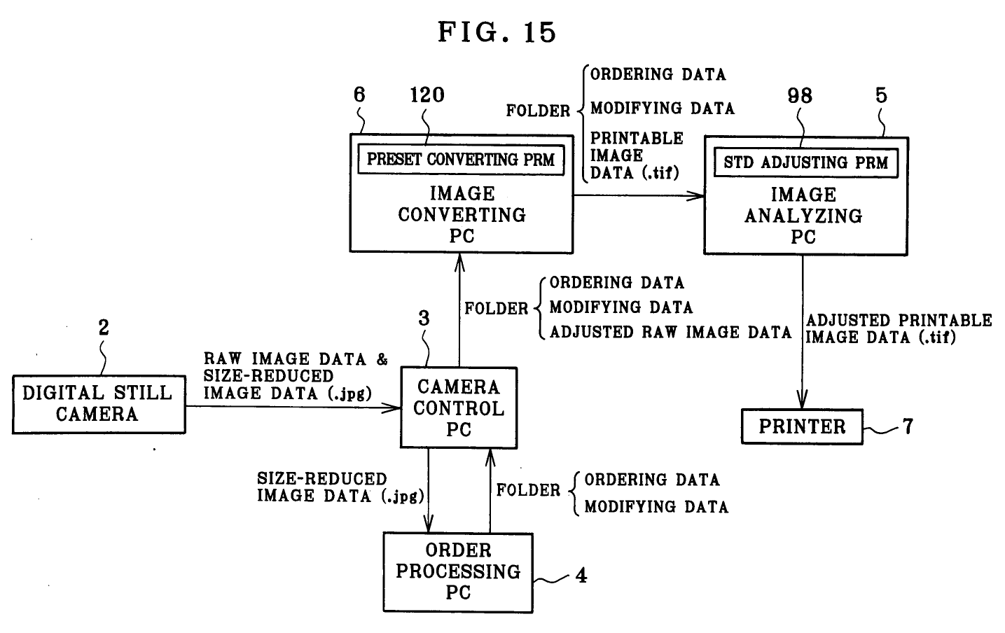

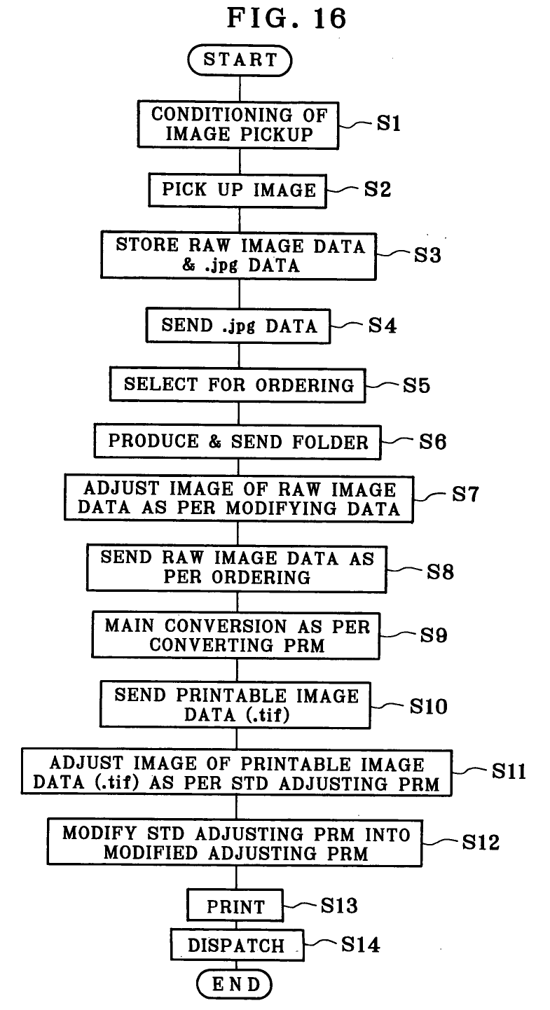

In the above embodiment, the modifying data is transmitted to the image converting computer 6, and used in the image conversion. Furthermore, FIGS. 15 and 16 illustrate one preferred embodiment, in which modifying data is transmitted to the camera control computer 3 and used in an image adjustment of raw image data. In the embodiment, the camera control computer 3 is used as means for adjusting raw image data in the step S7 of FIG. 16, and subjects to raw image data to processing of trimming before the image conversion. Thus, the image conversion can be completed in a reduced time because the raw image data with a reduced data size owing to the trimming can be subjected to the image conversion.

It is possible in the camera control computer 3 to check the ordering data. The raw image data related to the customer order can be transmitted from the camera control computer 3 to the image converting computer 6. This is advantageous in decreasing time for transmission of the raw image data, and reducing load in the data transmission within the image processing system.

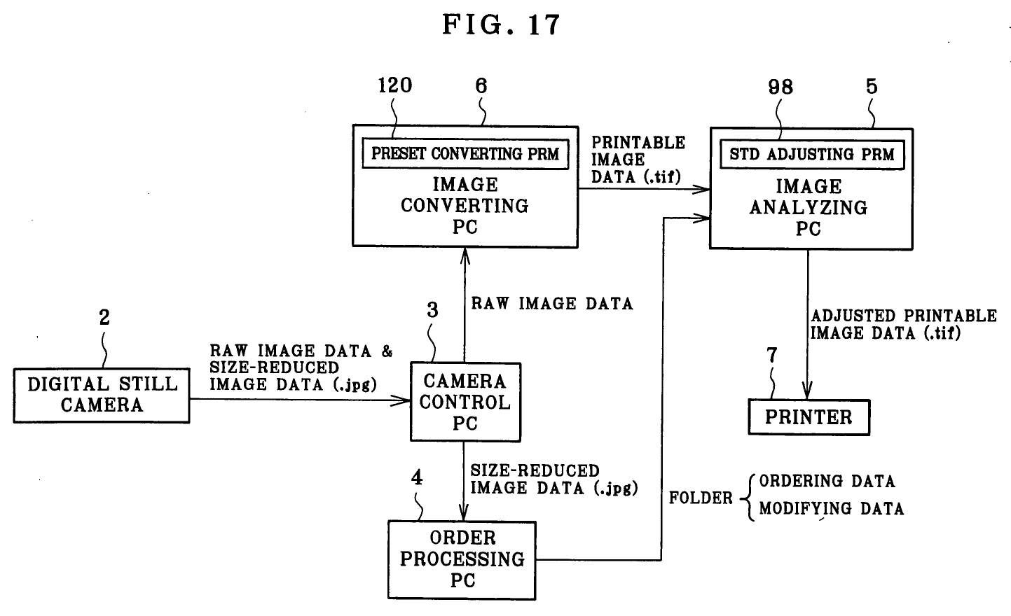

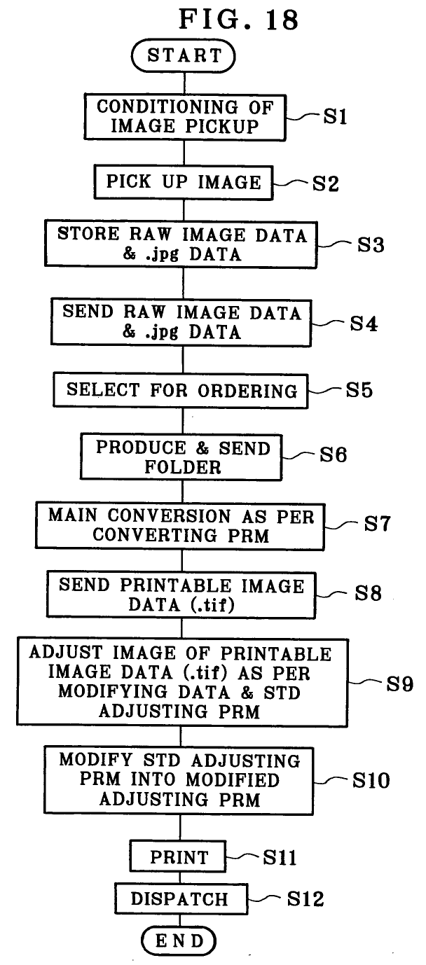

In FIGS. 17 and 18, one preferred embodiment is illustrated, in which the modifying data is transmitted to the image analyzing computer 5 at the step S5, for image adjustment of the printable image data at the step S9. This is advantageous in the automated processing, because the image converting computer 6 operates only for the image conversion of raw image data by use of the converting parameter.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. An image processing method of image processing of raw image data obtained by image pickup in a digital camera, wherein said digital camera produces a size-reduced image from said raw image data by size reduction, and writes data of said size-reduced image and said raw image data to a storage medium electrically, said image processing method comprising steps of:
displaying plural size-reduced images read from said storage medium on a display panel;
processing a customer order of printing by designating a selected one of said size-reduced images on said display panel;
processing said selected size-reduced image according to a standard adjusting parameter;
modifying said standard adjusting parameter to determine a modified adjusting parameter by considering preference in image quality;
converting selected raw image data into a printable image according to a prescribed converting parameter, said selected raw image data being associated with said selected size-reduced image, and read from said storage medium; and
processing said printable image according to said modified adjusting parameter.

2. An image processing method as defined in claim 1, wherein said raw image data is constituted by a three-color set of image signals output by an image pickup device of said digital camera, said size-reduced images are constituted by a signal obtained by JPEG compression of a color difference signal, and said printable image is constituted by a printer adapted signal.

3. An image processing method as defined in claim 1, wherein said standard adjusting parameter and said modified adjusting parameter are related to image adjustment of image quality, and said converting parameter is related to conditioning of image conversion of said raw image data into said printable image.

4. An image processing method as defined in claim 1, further comprising a step of processing quality modifying preference information for said size-reduced images together with said customer order, wherein said modified adjusting parameter is determined according to said quality modifying preference information.

5. An image processing method as defined in claim 4, wherein said selected raw image data is input from said storage medium without inputting other raw image data.

6. An image processing apparatus for image processing of raw image data obtained by image pickup in a digital camera, wherein said digital camera produces a size-reduced image from said raw image data by size reduction, and writes data of said size-reduced image and said raw image data to a storage medium electrically, said image processing apparatus comprising:
an image input unit for inputting data of plural size-reduced images and raw image data of at least one image from said storage medium;
a display panel for displaying said plural size-reduced images;
an order processor for processing a customer order of printing by designating a selected one of said size-reduced images on said display panel;
a first image processing unit for processing said selected size-reduced image according to a standard adjusting parameter;
a parameter modifier for modifying said standard adjusting parameter to determine a modified adjusting parameter by considering preference in image quality;
a second image processing unit for converting selected raw image data into a printable image according to a prescribed converting parameter, and for processing said printable image according to said modified adjusting parameter, said selected raw image data being associated with said selected size-reduced image, and read from said storage medium.

7. An image processing apparatus as defined in claim 6, wherein said raw image data is constituted by a three-color set of image signals output by an image pickup device of said digital camera, said size-reduced images are constituted by a signal obtained by JPEG compression of a color difference signal, and said printable image is constituted by a printer adapted signal.

8. An image processing apparatus as defined in claim 6, wherein said standard adjusting parameter and said modified adjusting parameter are related to image adjustment of image quality, and said converting parameter is related to conditioning of image conversion of said raw image data into said printable image.

9. An image processing apparatus as defined in claim 6, wherein said order processor further processes quality modifying preference information for said size-reduced images together with said customer order, and said parameter modifier determines said modified adjusting parameter according to said quality modifying preference information.

10. An image processing apparatus as defined in claim 9, wherein said image input unit inputs said selected raw image data from said storage medium without inputting other raw image data.

11. An image processing system, comprising a digital camera and an image processing apparatus;
said digital camera including an image pickup device for producing raw image data, there being a storage medium for electrically storing said raw image data and data of a size-reduced image produced from said raw image data by size reduction;
said image processing apparatus including:
an image input unit for inputting data of plural size-reduced images and raw image data of at least one image from said storage medium;
a display panel for displaying said plural size-reduced images;
an order processor for processing a customer order of printing by designating a selected one of said size-reduced images on said display panel;
a first image processing unit for processing said selected size-reduced image according to a standard adjusting parameter;
a parameter modifier for modifying said standard adjusting parameter to determine a modified adjusting parameter by considering preference in image quality;
a second image processing unit for converting selected raw image data into a printable image according to a prescribed converting parameter, and for processing said printable image according to said modified adjusting parameter, said selected raw image data being associated with said selected size-reduced image, and read from said storage medium.

12. An image processing system as defined in claim 11, wherein said raw image data is constituted by a three-color set of image signals output by said image pickup device of said digital camera, said size-reduced images are constituted by a signal obtained by JPEG compression of a color difference signal, and said printable image is constituted by a printer adapted signal.

13. An image processing system as defined in claim 11, wherein said standard adjusting parameter and said modified adjusting parameter are related to image adjustment of image quality, and said converting parameter is related to conditioning of image conversion of said raw image data into said printable image.

14. An image processing system as defined in claim 11, wherein said order processor further processes quality modifying preference information for said size-reduced images together with said customer order, and said parameter modifier determines said modified adjusting parameter according to said quality modifying preference information.

15. An image processing system as defined in claim 14, wherein said image input unit inputs said selected raw image data from said storage medium without inputting other raw image data.

16. A computer executable image processing program of image processing of raw image data obtained by image pickup in a digital camera, wherein said digital camera produces a size-reduced image from said raw image data by size reduction, and writes data of said size-reduced image and said raw image data to a storage medium electrically, said image processing program comprising:
a program code for inputting data of plural size-reduced images and raw image data of at least one image from said storage medium;
a program code for displaying said plural size-reduced images;
an order processing program code for processing a customer order of printing by designating a selected one of said size-reduced images being displayed;
a first image processing program code for processing said selected size-reduced image according to a standard adjusting parameter;
a program code for modifying said standard adjusting parameter to determine a modified adjusting parameter by considering preference in image quality; and
a second image processing program code for converting selected raw image data into a printable image according to a prescribed converting parameter, and of processing said printable image according to said modified adjusting parameter, said selected raw image data being associated with said selected size-reduced image, and read from said storage medium.

17. A computer executable image processing program as defined in claim 16, wherein said raw image data is constituted by a three-color set of image signals output by an image pickup device of said digital camera, said size-reduced images are constituted by a signal obtained by JPEG compression of a color difference signal, and said printable image is constituted by a printer adapted signal.

18. A computer executable image processing program as defined in claim 16, wherein said standard adjusting parameter and said modified adjusting parameter are related to image adjustment of image quality, and said converting parameter is related to conditioning of image conversion of said raw image data into said printable image.

19. A computer executable image processing program as defined in claim 16, wherein said order processing program code is for processing quality modifying preference information for said size-reduced images together with said customer order, and said parameter modifying program code is for determining said modified adjusting parameter according to said quality modifying preference information.

20. A computer executable image processing program as defined in claim 19, wherein said inputting program code is for inputting said selected raw image data from said storage medium without inputting other raw image data.

21. An image processing method of image processing of raw image data obtained by image pickup in a digital camera, wherein said digital camera produces a size-reduced image from said raw image data by size reduction, and writes data of said size-reduced image and said raw image data to a storage medium electrically, said image processing method comprising steps of:
(A) there being first and second modes a selected one of which is set, and when said first mode is set, then:
displaying said size-reduced image read from said storage medium;
processing said size-reduced image according to a standard adjusting parameter;
modifying said standard adjusting parameter to determine a first adjusting parameter by considering preference in image quality of said size-reduced image;
converting raw image data into a printable image according to a prescribed first converting parameter for printing said raw image data, said raw image data being associated with said size-reduced image, and read from said storage medium;
processing said printable image according to said first adjusting parameter; and
(B) when said second mode is set, then:
producing thinned raw image data by thinning said raw image data at a regular proportion;
converting said thinned raw image data according to a standard converting parameter, to produce a displayable thinned image;
displaying said displayable thinned image;
modifying said standard converting parameter to determine a second converting parameter by considering preference in image quality of said displayable thinned image;
processing said displayable thinned image according to a standard adjusting parameter after converting said displayable thinned image according to said second converting parameter;
modifying said standard adjusting parameter to determine a second adjusting parameter by considering preference in image quality of said displayable thinned image;
converting raw image data into a printable image according to said second converting parameter, said raw image data being associated with said displayable thinned image, and read from said storage medium;
processing said printable image according to said second adjusting parameter.

22. An image processing method as defined in claim 21, wherein said raw image data is constituted by a three-color set of image signals output by an image pickup device of said digital camera, said size-reduced image is constituted by a signal obtained by JPEG compression of a color difference signal, and said printable image is constituted by a printer adapted signal.

23. An image processing method as defined in claim 21, wherein said standard adjusting parameter and said first and second adjusting parameters are related to image adjustment of image quality, and said standard converting parameter and said first and second converting parameters are related to conditioning of image conversion of said raw image data into said printable image.

24. An image processing method as defined in claim 21, wherein at first said first mode is set, and if modification of said standard adjusting parameter is unacceptable to preference in image quality of said size-reduced image, then said second mode is set.

25. An image processing method as defined in claim 24, wherein said thinned raw image data in said second mode is produced time-sequentially together with a start of a sequence according to said first mode.

26. An image processing apparatus for image processing of raw image data obtained by image pickup in a digital camera, wherein said digital camera produces a size-reduced image from said raw image data by size reduction, and writes data of said size-reduced image and said raw image data to a storage medium electrically, said image processing apparatus comprising:
an image input unit for inputting said data of said size-reduced image and said raw image data from said storage medium;
a mode selector for setting a selected one of first and second modes;
a thinned raw image data generator, responsive to setting of said second mode, for producing thinned raw image data by thinning said raw image data at a regular proportion;
a first image processing unit, responsive to setting of said first mode, for image processing of said size-reduced image according to a standard adjusting parameter, and responsive to setting of said second mode, for converting said thinned raw image data according to a standard converting parameter, to produce a displayable thinned image;
a display panel for displaying said size-reduced image when said first mode is set, and for displaying said displayable thinned image when said second mode is set;
a parameter modifier, responsive to setting of said first mode, for modifying said standard adjusting parameter to determine a first adjusting parameter by considering preference in image quality of said size-reduced image, and responsive to setting of said second mode, for modifying said standard adjusting parameter and said standard converting parameter to determine a second adjusting parameter and a second converting parameter by considering preference in image quality of said displayable thinned image;
a second image processing unit, responsive to setting of said first mode, for converting said raw image data read from said storage medium into a printable image according to said first converting parameter, and for processing said printable image according to said first adjusting parameter, and also responsive to setting of said second mode, for converting said raw image data read from said storage medium into a printable image according to said second converting parameter, and for processing said printable image according to said second adjusting parameter.

27. An image processing apparatus as defined in claim 26, wherein said raw image data is constituted by a three-color set of image signals output by an image pickup device of said digital camera, said size-reduced image is constituted by a signal obtained by JPEG compression of a color difference signal, and said printable image is constituted by a printer adapted signal.

28. An image processing apparatus as defined in claim 26, wherein said standard adjusting parameter and said first and second adjusting parameters are related to image adjustment of image quality, and said standard converting parameter and said first and second converting parameters are related to conditioning of image conversion of said raw image data into said printable image.

29. An image processing apparatus as defined in claim 26, wherein at first said first mode is set, and if modification of said standard adjusting parameter is unacceptable to preference in image quality of said size-reduced image, then said second mode is set.

30. An image processing apparatus as defined in claim 29, wherein said thinned raw image data in said second mode is produced time-sequentially together with a start of a sequence according to said first mode.

31. An image processing system, comprising a digital camera and an image processing apparatus;
said digital camera including an image pickup device for producing raw image data, there being a storage medium for electrically storing said raw image data and data of a size-reduced image produced from said raw image data by size reduction;
said image processing apparatus including:
an image input unit for inputting said data of said size-reduced image and said raw image data from said storage medium;
a mode selector for setting a selected one of first and second modes;
a thinned raw image data generator, responsive to setting of said second mode, for producing thinned raw image data by thinning said raw image data at a regular proportion;
a first image processing unit, responsive to setting of said first mode, for image processing of said size-reduced image according to a standard adjusting parameter, and responsive to setting of said second mode, for converting said thinned raw image data according to a standard converting parameter, to produce a displayable thinned image;
a display panel for displaying said size-reduced image when said first mode is set, and for displaying said displayable thinned image when said second mode is set;
a parameter modifier, responsive to setting of said first mode, for modifying said standard adjusting parameter to determine a first adjusting parameter by considering preference in image quality of said size-reduced image, and responsive to setting of said second mode, for modifying said standard adjusting parameter and said standard converting parameter to determine a second adjusting parameter and a second converting parameter by considering preference in image quality of said displayable thinned image;
a second image processing unit, responsive to setting of said first mode, for converting said raw image data read from said storage medium into a printable image according to said first converting parameter, and for processing said printable image according to said first adjusting parameter, and also responsive to setting of said second mode, for converting said raw image data read from said storage medium into a printable image according to said second converting parameter, and for processing said printable image according to said second adjusting parameter.

32. An image processing system as defined in claim 31, wherein said raw image data is constituted by a three-color set of image signals output by said image pickup device of said digital camera, said size-reduced image is constituted by a signal obtained by JPEG compression of a color difference signal, and said printable image is constituted by a printer adapted signal.

33. An image processing system as defined in claim 31, wherein said standard adjusting parameter and said first and second adjusting parameters are related to image adjustment of image quality, and said standard converting parameter and said first and second converting parameters are related to conditioning of image conversion of said raw image data into said printable image.

34. An image processing system as defined in claim 31, wherein at first said first mode is set, and if modification of said standard adjusting parameter is unacceptable to preference in image quality of said size-reduced image, then said second mode is set.

35. An image processing system as defined in claim 34, wherein said thinned raw image data in said second mode is produced time-sequentially together with a start of a sequence according to said first mode.

36. A computer executable image processing program of image processing of raw image data obtained by image pickup in a digital camera, wherein said digital camera produces a size-reduced image from said raw image data by size reduction, and writes data of said size-reduced image and said raw image data to a storage medium electrically, said image processing program comprising:
a program code for inputting said data of said size-reduced image and said raw image data from said storage medium;
a program code for setting a selected one of first and second modes;
a program code, responsive to setting of said second mode, for producing thinned raw image data by thinning said raw image data at a regular proportion;
a first image processing program code, responsive to setting of said first mode, for image processing of said size-reduced image according to a standard adjusting parameter, and responsive to setting of said second mode, for converting said thinned raw image data according to a standard converting parameter, to produce a displayable thinned image;
a program code for displaying said size-reduced image when said first mode is set, and for displaying said displayable thinned image when said second mode is set;
a program code, responsive to setting of said first mode, for modifying said standard adjusting parameter to determine a first adjusting parameter by considering preference in image quality of said size-reduced image, and responsive to setting of said second mode, for modifying said standard adjusting parameter and said standard converting parameter to determine a second adjusting parameter and a second converting parameter by considering preference in image quality of said displayable thinned image;
a second image processing program code, responsive to setting of said first mode, for converting said raw image data read from said storage medium into a printable image according to said first converting parameter, and for processing said printable image according to said first adjusting parameter, and also responsive to setting of said second mode, for converting said raw image data read from said storage medium into a printable image according to said second converting parameter, and for processing said printable image according to said second adjusting parameter.

37. A computer executable image processing program as defined in claim 36, wherein said raw image data is constituted by a three-color set of image signals output by an image pickup device of said digital camera, said size-reduced image is constituted by a signal obtained by JPEG compression of a color difference signal, and said printable image is constituted by a printer adapted signal.

38. A computer executable image processing program as defined in claim 36, wherein said standard adjusting parameter and said first and second adjusting parameters are related to image adjustment of image quality, and said standard converting parameter and said first and second converting parameters are related to conditioning of image conversion of said raw image data into said printable image.

39. A computer executable image processing program as defined in claim 36, wherein at first said first mode is set, and if modification of said standard adjusting parameter is unacceptable to preference in image quality of said size-reduced image, then said second mode is set.

40. A computer executable image processing program as defined in claim 39, wherein said thinned raw image data in said second mode is produced time-sequentially together with a start of a sequence according to said first mode.

41. An image processing method of image processing of raw image data obtained by image pickup in a digital camera, wherein said digital camera produces a size-reduced image from said raw image data by size reduction, and writes data of said size-reduced image and said raw image data to a storage medium electrically, said image processing method comprising steps of:
displaying plural size-reduced images read from said storage medium on a display panel;
processing a customer order of printing by designating a selected one of said size-reduced images on said display panel;
converting selected raw image data into a printable image according to a prescribed converting parameter, said selected raw image data being associated with said selected size-reduced image, and read from said storage medium;
displaying said printable image on said display panel;
processing said printable image according to a standard adjusting parameter;
modifying said standard adjusting parameter for image adjustment of said printable image by considering preference in image quality.

42. An image processing method as defined in claim 41, wherein said raw image data is constituted by a three-color set of image signals output by an image pickup device of said digital camera, said size-reduced images are constituted by a signal obtained by JPEG compression of a color difference signal, and said printable image is constituted by a printer adapted signal.

43. An image processing method as defined in claim 41, wherein said standard adjusting parameter is related to image adjustment of image quality, and said converting parameter is related to conditioning of image conversion of said raw image data into said printable image.

44. An image processing method as defined in claim 41, wherein said selected raw image data is input from said storage medium without inputting other raw image data.

45. An image processing method as defined in claim 41, further comprising a step of processing quality modifying preference information for said size-reduced images together with said customer order, and said modified adjusting parameter is determined according to said quality modifying preference information.

46. An image processing method as defined in claim 45, wherein said quality modifying preference information comprises trimming preference information of designating an image region of being trimmed, and said selected raw image data is trimmed according to said trimming preference information.

47. An image processing method as defined in claim 45, wherein said quality modifying preference information comprises trimming preference information of designating an image region of being trimmed, and said selected raw image data is trimmed according to said trimming preference information at a time of converting said selected raw image data into said printable image.

48. An image processing method as defined in claim 45, wherein said quality modifying preference information comprises trimming preference information of designating an image region of being trimmed, and said printable image is trimmed according to said trimming preference information.

49. An image processing apparatus for image processing of raw image data obtained by image pickup in a digital camera, wherein said digital camera produces a size-reduced image from said raw image data by size reduction, and writes data of said size-reduced image and said raw image data to a storage medium electrically, said image processing apparatus comprising:
an image input unit for inputting data of plural size-reduced images and raw image data of at least one image from said storage medium;
a display panel for displaying said plural size-reduced images;
an order processor for processing a customer order of printing by designating a selected one of said size-reduced images on said display panel;
a first image processing unit for converting selected raw image data into a printable image according to a prescribed converting parameter, said selected raw image data being associated with said selected size-reduced image, and read from said storage medium;
a second image processing unit for processing said printable image according to a standard adjusting parameter;
a parameter modifier for modifying said standard adjusting parameter for image adjustment of said printable image by considering preference in image quality.

50. An image processing apparatus as defined in claim 49, wherein said raw image data is constituted by a three-color set of image signals output by an image pickup device of said digital camera, said size-reduced images are constituted by a signal obtained by JPEG compression of a color difference signal, and said printable image is constituted by a printer adapted signal.

51. An image processing apparatus as defined in claim 49, wherein said standard adjusting parameter is related to image adjustment of image quality, and said converting parameter is related to conditioning of image conversion of said raw image data into said printable image.

52. An image processing apparatus as defined in claim 49, wherein said selected raw image data is input from said storage medium without inputting other raw image data.

53. An image processing apparatus as defined in claim 52, wherein said order processor further processes quality modifying preference information for said size-reduced images together with said customer order, and said parameter modifier determines said modified adjusting parameter according to said quality modifying preference information.

54. An image processing apparatus as defined in claim 53, wherein said quality modifying preference information comprises trimming preference information of designating an image region of being trimmed;
further comprising a trimming unit for trimming said selected raw image data according to said trimming preference information.

55. An image processing apparatus as defined in claim 53, wherein said quality modifying preference information comprises trimming preference information of designating an image region of being trimmed, and said first image processing unit trims said selected raw image data according to said trimming preference information at a time of converting said selected raw image data into said printable image.

56. An image processing apparatus as defined in claim 53, wherein said quality modifying preference information comprises trimming preference information of designating an image region of being trimmed, and said second image processing unit trims said printable image according to said trimming preference information.

57. An image processing system, comprising a digital camera and an image processing apparatus;
said digital camera including an image pickup device for producing raw image data, there being a storage medium for electrically storing said raw image data and data of a size-reduced image produced from said raw image data by size reduction;
said image processing apparatus including:
an image input unit for inputting data of plural size-reduced images and raw image data of at least one image from said storage medium;
a display panel for displaying said plural size-reduced images;
an order processor for processing a customer order of printing by designating a selected one of said size-reduced images on said display panel;
a first image processing unit for converting selected raw image data into a printable image according to a prescribed converting parameter, said selected raw image data being associated with said selected size-reduced image, and read from said storage medium;
a second image processing unit for processing said printable image according to a standard adjusting parameter;
a parameter modifier for modifying said standard adjusting parameter for image adjustment of said printable image by considering preference in image quality.

58. An image processing system as defined in claim 57, wherein said raw image data is constituted by a three-color set of image signals output by said image pickup device of said digital camera, said size-reduced images are constituted by a signal obtained by JPEG compression of a color difference signal, and said printable image is constituted by a printer adapted signal.

59. An image processing system as defined in claim 57, wherein said standard adjusting parameter is related to image adjustment of image quality, and said converting parameter is related to conditioning of image conversion of said raw image data into said printable image.

60. An image processing system as defined in claim 57, wherein said selected raw image data is input from said storage medium without inputting other raw image data.

61. An image processing system as defined in claim 60, wherein said order processor further processes quality modifying preference information for said size-reduced images together with said customer order, and said parameter modifier determines said modified adjusting parameter according to said quality modifying preference information.

62. An image processing system as defined in claim 61, wherein said quality modifying preference information comprises trimming preference information of designating an image region of being trimmed;
further comprising a trimming unit for trimming said selected raw image data according to said trimming preference information.

63. An image processing system as defined in claim 61, wherein said quality modifying preference information comprises trimming preference information of designating an image region of being trimmed, and said first image processing unit trims said selected raw image data according to said trimming preference information at a time of converting said selected raw image data into said printable image.

64. An image processing system as defined in claim 61, wherein said quality modifying preference information comprises trimming preference information of designating an image region of being trimmed, and said second image processing unit trims said printable image according to said trimming preference information.

65. A computer executable image processing program of image processing of raw image data obtained by image pickup in a digital camera, wherein said digital camera produces a size-reduced image from said raw image data by size reduction, and writes data of said size-reduced image and said raw image data to a storage medium electrically, said image processing program comprising:
a program code for inputting data of plural size-reduced images and raw image data of at least one image from said storage medium;
a program code for displaying said plural size-reduced images;
an order processing program code for processing a customer order of printing by designating a selected one of said size-reduced images being displayed;
a first image processing program code for converting selected raw image data into a printable image according to a prescribed converting parameter, said selected raw image data being associated with said selected size-reduced image, and read from said storage medium;
a second image processing program code for processing said printable image according to a standard adjusting parameter;
a parameter modifying program code for modifying said standard adjusting parameter for image adjustment of said printable image by considering preference in image quality.

66. A computer executable image processing program as defined in claim 65, wherein said raw image data is constituted by a three-color set of image signals output by an image pickup device of said digital camera, said size-reduced images are constituted by a signal obtained by JPEG compression of a color difference signal, and said printable image is constituted by a printer adapted signal.

67. A computer executable image processing program as defined in claim 65, wherein said standard adjusting parameter is related to image adjustment of image quality, and said converting parameter is related to conditioning of image conversion of said raw image data into said printable image.

68. A computer executable image processing program as defined in claim 65, wherein said selected raw image data is input from said storage medium without inputting other raw image data.

69. A computer executable image processing program as defined in claim 68, wherein said order processing program code is further for processing quality modifying preference information for said size-reduced images together with said customer order, and said parameter modifying program code is for determining said modified adjusting parameter according to said quality modifying preference information.

70. A computer executable image processing program as defined in claim 69, wherein said quality modifying preference information comprises trimming preference information of designating an image region of being trimmed;
further comprising a trimming program code for trimming said selected raw image data according to said trimming preference information.

71. A computer executable image processing program as defined in claim 69, wherein said quality modifying preference information comprises trimming preference information of designating an image region of being trimmed, and said first image processing program code is for trimming said selected raw image data according to said trimming preference information at a time of converting said selected raw image data into said printable image.

72. A computer executable image processing program as defined in claim 69, wherein said quality modifying preference information comprises trimming preference information of designating an image region of being trimmed, and said second image processing program code is for trimming said printable image according to said trimming preference information.
